(19) United States
(12) Patent Application Publication
(10) Pub. No.: US 2026/0119844 A1
(43) Pub. Date: Apr. 30, 2026

(54) TEMPLATE GENERATION UTILIZING DISCRIMINATIVE MODELING

(71) Applicant: Dell Products L.P., Round Rock, TX (US)

(72) Inventors: Karthik Hubli, Northborough, MA (US); Siva Rama Krishna Kottapalli, Dracut, MA (US)

(21) Appl. No.: 18/926,273

(22) Filed: Oct. 24, 2024

(51) Int. Cl. G06N 3/0475; G06N 3/0455; G06N 3/08

(52) U.S. Cl. CPC G06N 3/0475; G06N 3/0455; G06N 3/08

(57) ABSTRACT

Automatic generation of log message templates from log messages can be performed and enhanced using trained discriminator model. Expression processor can separate main content portion from structured information items of log message. For log message, sequence of encoded tokens can be generated. Some encoded tokens can be replaced with masked tokens to generate masked sequence. Generator model can be trained to predict encoded tokens that were replaced with masked tokens in masked sequence. Modified sequence, comprising some encoded tokens and some predicted tokens replacing other encoded tokens, can be generated. Discriminator model can be trained to predict whether token in modified sequence is original encoded token or replaced token. For subsequent log message, trained discriminator model can infer whether token associated with log message is a dynamic token, and, if so, dynamic token can be replaced with defined character during generation of log message template.

### BACKGROUND

Computer systems, such as server and storage systems, can be employed to perform various desired operations and services. In connection with various types of operations performed by a computer system, the computer system can generate various log messages relating to the operations. In the context of server and storage system operations, log messages can constitute a desirable component for continuous monitoring, diagnostic assessment, and performance optimization for these computer systems.

The above-described description is merely intended to provide a contextual overview regarding computer systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise: with regard to a first sequence comprising respective encoded tokens partially representative of a log message and a masked token that replaces an encoded token associated with the log message in the first sequence, training, by a system comprising at least one processor, a generator model to generate a predicted token that can be a prediction of the encoded token that was replaced by the masked token in the first sequence, based on a first artificial intelligence-based analysis that can be performed on the first sequence using the generator model. The method also can comprise: generating, by the system, a second sequence comprising respective tokens that can comprise the predicted token and at least some of the respective encoded tokens, wherein the predicted token can be a replacement token that replaces the masked token of the first sequence to facilitate generating the second sequence. The method further can comprise: based on a second artificial intelligence-based analysis that can be performed, using a discriminator model, on the second sequence and respective label values associated with the respective tokens, training, by the system, the discriminator model to predict whether the respective tokens of the second sequence are the respective encoded tokens or the replacement token, wherein the training of the discriminator model can enable the discriminator model to perform inferential detection of a dynamic token associated with a subsequent log message and enable replacement of the dynamic token with a defined mark to facilitate generation of a log message template that can be representative of the subsequent log message and can comprise the defined mark in place of the dynamic token.

In certain embodiments, the disclosed subject matter can comprise a system that can comprise at least one memory that can store computer executable components, and at least one processor that can execute computer executable components stored in the at least one memory. The computer executable components can comprise a tokenizer that can generate a first sequence comprising respective encoded tokens that can be representative of part of a log message, wherein a masked token can replace an encoded token associated with the log message in the first sequence. The tokenizer can generate a second sequence comprising respective tokens that can comprise a predicted token and at least some of the respective encoded tokens, wherein the predicted token can be a replacement token that can replace the masked token of the first sequence to facilitate generation of the second sequence, wherein the predicted token can be a prediction of the encoded token that was replaced by the masked token in the first sequence, wherein the predicted token was obtained as output from a generator model that was trained to generate the predicted token, and wherein the predicted token was generated based on a first result of a first artificial intelligence-based analysis performed on the first sequence using the generator model. A discriminator model can be trained to predict whether the respective tokens of the second sequence are the respective encoded tokens or the replacement token, based on a second result of a second artificial intelligence-based analysis performed, using the discriminator model, on the second sequence and respective label information items associated with the respective tokens. The computer executable components also can comprise a detector that can perform, using the discriminator model, inferential detection of a dynamic token associated with a subsequent log message to facilitate replacement of the dynamic token with a defined symbol to facilitate generation of a log message template that can be representative of the subsequent log message and can comprise the defined symbol in place of the dynamic token.

In still other embodiments, the disclosed subject matter can comprise a non-transitory machine-readable medium, comprising executable instructions that, when executed by at least one processor, can facilitate performance of operations. The operations can comprise: in response to receiving a log message, generating, a sequence, comprising respective encoded tokens that can be partially representative of the log message, wherein the log message further can comprise respective structured information items. The operations also can comprise performing, using a discriminator model, an artificial intelligence-based analysis on the respective encoded tokens of the sequence. The operations further can comprise: based on a result of the artificial intelligence-based analysis, inferring, using the discriminator model, whether the respective encoded tokens are respective dynamic tokens to facilitate generating a log message template that can be representative of the log message and can comprise one or more defined symbols in place of one or more of the respective encoded tokens inferred to be one or more respective dynamic tokens.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage and perform generation of log message templates from log messages, in accordance with various aspects and embodiments of the disclosed subject matter.

FIG. 2 depicts a block diagram of a non-limiting example process flow that can desirably manage and perform training of a generator model and a discriminator model to facilitate generation of log message templates from log messages, in accordance with various aspects and embodiments of the disclosed subject matter.

FIG. 3 illustrates a diagram of a non-limiting example byte pair encoding (BPE) process that can be performed to encode and tokenize main content information items of a main content portion of a log message to facilitate generating a sequence of encoded tokens that can be representative of the main content information items, in accordance with various aspects and embodiments of the disclosed subject matter.

FIG. 4 depicts a block diagram of a non-limiting example generator-discriminator model that can perform generator tasks and discriminator tasks to facilitate log message template generation and/or extraction, in accordance with various aspects and embodiments of the disclosed subject matter.

FIG. 5 illustrates a block diagram of a non-limiting example process flow that can desirably for generation of log message templates from log messages using a trained discriminator model, in accordance with various aspects and embodiments of the disclosed subject matter.

FIG. 6 presents a diagram of a log message template generation, in accordance with various aspects and embodiments of the disclosed subject matter.

FIG. 7 illustrates a block diagram of a non-limiting example model that can comprise a transformer-based architecture, in accordance with various aspects and embodiments of the disclosed subject matter.

FIG. 8 illustrates a flow chart of an example method that can desirably train a generator model and a discriminator model to enable the discriminator model to perform inferential detection of a dynamic token associated with a log message and enable replacement of the dynamic token with a defined mark to facilitate generation of a log message template that can be representative of the log message and can comprise the defined mark in place of the dynamic token, in accordance with various aspects and embodiments of the disclosed subject matter.

FIG. 9 depicts a flow chart of an example method that can desirably train a generator model to predict tokens that were replaced by masked tokens in a masked sequence of tokens associated with a log message, in accordance with various aspects and embodiments of the disclosed subject matter.

FIG. 10 depicts a flow chart of an example method that can desirably train a discriminator model to infer or predict tokens that were replaced by predicted tokens (e.g., by the generator model) in a modified sequence of tokens associated with a log message to facilitate learning to infer or detect dynamic tokens in a subsequent log message, in accordance with various aspects and embodiments of the disclosed subject matter.

FIG. 11 depicts a flow chart of an example method that can desirably use a trained discriminator model to infer or detect dynamic tokens associated with a log message, and can desirably generate a log message template that can comprise defined marks that can replace the dynamic tokens associated with the log message, in accordance with various aspects and embodiments of the disclosed subject matter.

FIG. 12 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, methods, and techniques that can desirably (e.g., automatically, suitably, efficiently, reliably, enhancedly, and/or optimally) generate log message templates that can be representative of log messages utilizing discriminative modeling. Computer systems, such as server and storage systems, can be employed to perform various desired operations and services. In connection with various types of operations performed by a computer system, the computer system can generate various log messages relating to the operations. In the context of server and storage system operations, log messages can constitute a desirable component for continuous monitoring, diagnostic assessment, and performance optimization for these computer systems.

One of the significant challenges with generating log message templates can be that some of the log message information can be dynamic information (e.g., dynamic tokens) that can vary from operation to operation. The efficacy of log analytics can be undesirably and significantly impeded by the variability of dynamic tokens embedded within the log messages. Such dynamic tokens can comprise or relate to, for example, disk identifiers (IDs) associated with a computer system (e.g., a storage system of a computer system), serial numbers (e.g., serial numbers associated with a disk or other computer system component), partition names and IDs associated with a computer system component (e.g., component of the storage system), timestamps and dates associated with operations performed by the computer system, user IDs and access credentials associated with users who are accessing or using the computer system. These dynamic tokens can undesirably obfuscate desired (e.g., wanted, useful, or valuable) information associated with the log messages, which can make log analysis undesirably challenging, can undesirably increase the amount of data storage that has to be utilized in connection with storing the dynamic information, which can lead to undesirably higher costs associated with data storage, can undesirably complicate anonymization efforts to anonymize information relating to users, which can undesirably risk data privacy breaches, and/or can result in manual log message templates having to be created and/or supervised learning methods having to be employed to process log messages, which can be undesirably consuming and prone to error.

Existing techniques for log message template generation can be deficient in a number of other ways, particularly with regard to handling dynamic information of log messages. Some techniques can employ large language models (LLMs) to process log messages and generate log message templates. LLMs, particularly LLMs that can have a relatively high number of parameters (e.g., billions of parameters or other high number of parameters), can have undesirably substantial (e.g., high) resource utilization, which can result in undesirably slower processing times and undesirably higher operational costs. Also, the use of LLMs for log message processing and template generation can involve precise prompt engineering for LLMs and can introduce an undesirable layer of complexity that can result in unpredictable outcomes and an undesirably higher failure rate in achieving desired results with regard to processing log messages and generating log message templates. This complexity can be undesirably exacerbated when dealing with dynamic log data, where prompt-based models, such as prompt-based LLM models, can have problems maintaining (e.g., can fail to maintain) accuracy and consistency in the processing of log messages and generating log message templates. Further, if dynamic tokens of log messages are replaced with other tokens in connection with generating log message templates, LLM models may not be able to recover the original tokens with certainty (e.g., with 100% certainty or other high level of certainty).

Certain other existing techniques can utilize regular expressions (regex) for log message template creation (e.g., manual log message template creation). Such existing techniques utilizing regular expressions can be inadequate for handling the complexity and variability of log messages in storage systems, particularly log messages comprising dynamic information.

Other existing techniques for log message template generation, such as frequent pattern mining, clustering, log-structure heuristics, longest common subsequence, evolutionary, and neural techniques, also can have various deficiencies, including deficiencies with regard to handling of dynamic information in log messages, that can result in undesirable generation of log message templates.

The challenges in analysis of log message data (e.g., raw log message data) can include, for example, the unstructured nature of raw log messages, complexity of log message template extraction using existing techniques, irrelevant or extraneous details and noise in the log message data, dynamic information (e.g., dynamic token) variations, log message variations, and multi-line log messages. With regard to the unstructured nature of raw log messages, raw log messages can lack a consistent structure, which can make it difficult to extract meaningful patterns and insights from the log messages. While some components, such as timestamps (e.g., 2024 Jun. 1 14:30:00), severity levels (e.g., INFO, WARNING, or ERROR), can exhibit a degree of regularity, the main content of the log message, which can be the information of most interest to users and systems analyzing log message data, can remain unstructured. For example, in a log message, there can be a raw log message entry: 2024 May 15 10:30:45 [ERROR] Disk I/O error on device/dev/sda1, wherein the unstructured content can comprise: Disk I/O error on device/dev/sda1. Extracting meaningful patterns from this main content of the log message can be nontrivial due to the variability in message length, word order, vocabulary used, and other linguistic semantics.

With regard to log message template complexity, existing log message template extraction techniques can rely heavily on regular expressions and handcrafted rules. However, these existing techniques can become undesirably and increasingly complex and can be difficult to maintain over time. Ensuring that rules remain up to date can involve (e.g., require) constant attention, especially as system configurations evolve. For example, a regex pattern designed to extract disk usage information may fail to match new log messages that include additional details, such as disk serial numbers. Also, handcrafted rules may not account for variations in log message formatting, which can lead to missed matches or false positives.

Regarding irrelevant or extraneous details and noise, raw log messages often can contain extraneous information that can add undesirable complexity without significantly improving model accuracy. Information like Internet protocol (IP) addresses, timestamps, system specific identifiers may add some value, but they may decrease the performance of the machine learning models which may not be designed to work with specific system or IP addresses. For example, a log message can comprise a raw log entry, such as: 2024 May 15 10:30:45 [INFO] Request from IP 127.0.1.100: GET/api/data, wherein the irrelevant details may include timestamp, severity level, and IP address. These details can add undesirable complexity to the log message analysis process without significantly improving model accuracy. Separating signal from noise can be desirable (e.g., wanted, essential, or optimal) to reduce data dimensionality, improve model performance, and enhance interpretability of data.

With regard to dynamic information variations in log messages, log messages often can contain dynamic tokens, such as, for example, user identifiers (IDs), session IDs, transaction IDs, and/or other types of dynamic tokens. These dynamic tokens can vary in value and format, which can make it challenging (e.g., problematic) to extract meaningful information from the log messages.

Regarding log message variations, log messages may have variations in wording, punctuation, or formatting, which can make it challenging to extract meaningful information from the log messages. For example, a first log message can comprise log message content, such as: Disk usage exceeded 90% on/dev/sda1, while a second log message may comprise log message content, such as: Disk usage is 95% on/dev/sda1. These two example log messages are providing similar information, however, they vary in the wording and format used for providing such information relating to disk usage.

With regard to multi-line log messages, some log messages may span multiple lines, which can make it challenging to extract meaningful information from the log messages. For example, a raw log message can comprise the following information:
Error occurred at 2024 Jun. 1 14:30:00
Error message: Disk usage exceeded 99% on/dev/sda1
Error code: 1234.

These challenges can highlight the desire (e.g., want or need) for an automated, efficient, and scalable solution that can extract meaningful patterns and templates from raw log message data, without having to rely on manual rules or regex patterns.

Accordingly, the disclosed subject matter can address and overcome the aforementioned deficiencies and other deficiencies of the existing systems and techniques. To that end, techniques that can desirably (e.g., automatically, dynamically, suitably, reliably, efficiently, enhancedly, and/or optimally) manage and perform generation of log message templates from log messages are presented. A system can comprise a template generation manager component that can desirably manage and perform generation of log message templates from log messages using a discriminator model that can identify and extract, or facilitate extracting, dynamic information items (e.g., dynamic tokens) from log messages, wherein the dynamic information items can be replaced by defined marks (e.g., defined symbols or defined characters), to facilitate generation of log message templates that can be representative of the log messages and can comprise the defined marks in place of the dynamic information items. In some embodiments, the template generation manager component can employ and train a generator model that can perform various generator tasks and the discriminator model that can perform various discriminator tasks, such as described herein. In other embodiments, the template generation manager component can employ and train a generator-discriminator model that can comprise a generator model component that can perform the various generator tasks and a discriminator model component that can perform the various discriminator tasks. In certain embodiments, the generator model and the discriminator model can be jointly or concurrently trained.

The template generation manager component can receive or access log messages associated with a computer-based system(s) (e.g., server, storage system, or other computer-based system) from the computer-based system(s), a data store, or another data source. The log messages (e.g., raw or unprocessed log messages) can relate to operations, files, file directories, entities, functions, or other information of or associated with the computer-based system(s). The log messages can comprise structured information items and/or unstructured information items. Unstructured information items, which can comprise dynamic information items, often can be located in a main content portion (e.g., main body) of a log message.

The template generation manager component can comprise an expression processor component that can separate (e.g., divide or segment) the main content portion from respective information items (e.g., structured information items) of the log message, based at least in part on the results of analyzing the log message and using (e.g., applying) a group of regular expressions. The template generation manager component can comprise a tokenizer component that can generate a sequence of encoded tokens that can be representative of the other respective information items (e.g., unstructured information items or other information items) of the main content portion of the log message, with regard to each log message of a group of log messages. The template generation manager component can employ a token sequence processor component that can randomly replace a desired portion of the encoded tokens of the sequence with masked tokens to generate a masked sequence comprising the remaining encoded tokens and the masked tokens that have replaced the desired portion of the encoded tokens.

The template generation manager component, employing a trainer component (e.g., a trainer component of an artificial intelligence (AI) component), can train a generator model to predict encoded tokens that were replaced with the masked tokens in the masked sequence. For instance, the trainer component can input the masked sequence into the generator model. The generator model can perform an AI-based analysis on the tokens (e.g., respective encoded tokens and respective masked tokens) of the masked sequence. Based at least in part on the results of the AI-based analysis, the generator model can be trained to predict, and can predict, the encoded tokens (e.g., the values of the replaced encoded tokens) that were replaced with the masked tokens in the masked sequence. For instance, based at least in part on the results of the AI-based analysis, the generator model can determine and generate respective predicted tokens that can be respective predictions of the respective encoded tokens that were replaced with the masked tokens in the masked sequence.

The token sequence processor component can generate a modified sequence of tokens that can comprise some encoded tokens (e.g., that were part of the original sequence and the masked sequence) and some of the predicted tokens that can replace the masked tokens and/or certain other encoded tokens (e.g., that were part of the original sequence and the masked sequence). The trainer component can input the modified sequence of tokens into a discriminator model to facilitate training the discriminator model to distinguish between the original encoded tokens and the replacement tokens (e.g., the predicted tokens), based at least in part on a token replacement detection (TRD) technique performed by the discriminator model. The discriminator model can perform an AI-based analysis on the modified sequence of tokens. Based at least in part on the results of such AI-based analysis, the discriminator model can be trained to predict, and can predict, whether each of the respective tokens in modified sequence is an original encoded token or a replaced token. Detection of replacement tokens in the modified sequence of tokens associated with a log message can correspond, correlate, and/or be aligned with the task of detecting dynamic tokens in a log message, and such training of the discriminator model can enable the discriminator model to desirably infer (e.g., inferentially determine or detect) whether tokens associated with log messages are dynamic tokens or not.

The trainer component can perform one or more iterations of training the generator model and the discriminator model by determining respective losses (e.g., errors) associated with the respective results produced by the generator model and the discriminator model during each training iteration, and updating respective parameters associated with the generator model and the discriminator model to mitigate (e.g., reduce or minimize) such respective losses, such as described herein. Training of the generator model and the discriminator model can continue until defined model management criteria is satisfied (e.g., until a defined accuracy criterion (of the defined model management criteria) indicating that the model (e.g., generator model or discriminator model) is desirably accurate in its predictions or inferences has been satisfied (e.g., met or exceeded), or until a defined model training stopping criterion (of the defined model management criteria) is satisfied).

With regard to a subsequent log message, the expression processor component can separate the main content portion from respective information items (e.g., structured information items) of the subsequent log message, based at least in part on the results of analyzing the subsequent log message and using (e.g., applying) the group of regular expressions. The tokenizer component can generate a sequence of respective encoded tokens that can be representative of respective main content information items (e.g., unstructured information items) of the main content portion of the subsequent log message.

The discriminator model (e.g., trained discriminator model) can perform an AI-based analysis on the sequence of respective encoded tokens. Based at least in part on the results of such AI-based analysis, the discriminator model can infer whether each encoded token of the respective encoded tokens is a dynamic token or not, based at least in part on respective probabilities that the respective encoded tokens are respective dynamic tokens and a defined threshold probability relating to dynamic token detection (e.g., defined threshold probability indicative of whether an encoded token is a dynamic token). With regard to one or more encoded tokens inferred or determined to be one or more dynamic tokens, the template generation manager component, employing a template generator component, can replace the one or more dynamic tokens with one or more defined marks, which can be representative or indicative of dynamic tokens, to facilitate generation of the log message template that can be representative of the subsequent log message. The template generation manager component can generate such log message template, which can comprise the respective information items (e.g., the respective structured information items), other respective information items (e.g., other information items (other than the one or more dynamic information items) of the main content portion of the subsequent log message), and the defined marks (e.g., which replaced the one or more dynamic information items (e.g., the one or more dynamic tokens)).

The disclosed subject matter, by employing the template generation manager component and associated models (e.g., generator model and discriminator model; or a generator-discriminator model), and the enhanced techniques described herein, can desirably (e.g., automatically, dynamically, suitably, reliably, efficiently, enhancedly, and/or optimally) enhance generation of log message templates (e.g., enhanced consistency, reliability, and accuracy in generation of log message templates); enhance analysis of log message templates; enhance adaptability of analysis of log messages (e.g., enhanced, automatic, and dynamic adapting to changes in log message patterns without manual intervention by a user), generation of log message templates, and processing and analysis of log message templates; enhance (e.g., improve, increase, and/or optimize) performance of the computer system associated with (e.g., comprising) the template generation manager component; enhance training and performance (e.g., enhance inferences, determinations, and/or probability determinations) of AI-based models (e.g., the generator model, the discriminator model, and/or other AI-based model employed by the template generation manager component); enhance anonymization and data privacy of users and data associated with log messages (e.g., by streamlining and/or anonymizing analysis of vast amounts of log message data generated by server and storage systems); enhance compression of data associated with log messages and log message templates; reduce (e.g., decrease or minimize) the amount of time, amount of resources, complexity, and costs (e.g., financial costs or other type of cost) associated with processing of log messages, generation of log message templates, and/or analysis of log message templates; reduce maintenance costs associated with computer-based systems (e.g., server and/or storage systems) associated with (e.g., generating) log messages; enhance scalability of processing of log messages, generation of log message templates, and analysis of log message templates; and utilize less feature engineering operations or steps in connection with generation of log message templates, as compared to existing systems, methods, and techniques for log message generation and analysis.

These and other aspects and embodiments of the disclosed subject matter will now be described with respect to the drawings.

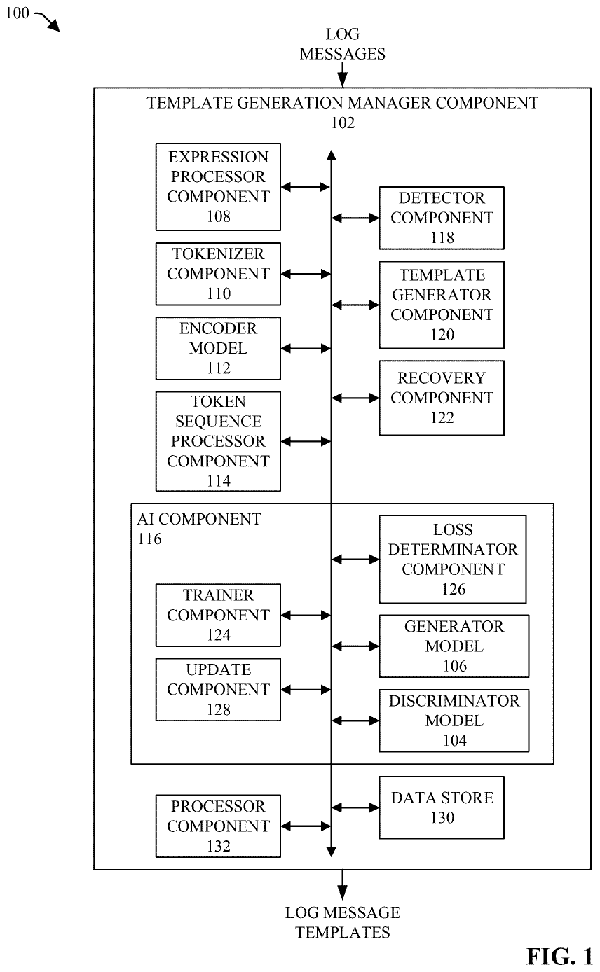

Referring now to the drawings, FIG. 1 illustrates a block diagram of a non-limiting example system 100 that can desirably (e.g., autonomously, automatically, dynamically, suitably, reliably, efficiently, enhancedly, and/or optimally) manage and perform generation of log message templates from log messages, in accordance with various aspects and embodiments of the disclosed subject matter. In accordance with various embodiments, the system 100 can comprise a template generation manager component 102 that can desirably manage and perform generation of log message templates from log messages using a discriminator model 104 (e.g., a discriminator model that can have a transformer-based discriminative architecture) that can identify and extract, or facilitate extracting, dynamic information items (e.g., dynamic tokens) from log messages, and replacing the dynamic information items with defined marks (e.g., defined symbols or defined characters), to facilitate generation of log message templates that can be representative of the log messages and can comprise the defined marks in place of the dynamic information items. In some embodiments, the template generation manager component 102 can employ and train a generator model 106 that can perform various generator tasks and the discriminator model 104 that can perform various discriminator tasks, such as described herein. In other embodiments, the template generation manager component 102 can employ and train a generator-discriminator model that can comprise a generator model component that can perform the various generator tasks and a discriminator model component that can perform the various discriminator tasks, such as described herein. In certain embodiments, the generator model 106 and the discriminator model 104 can be jointly or concurrently trained, such as described herein.

The template generation manager component 102 can receive (e.g., as input) log messages (e.g., raw log messages comprising raw or unprocessed log message data) from one or more devices, a data store, or another data source that can be associated with (e.g., communicatively connected to) the template generation manager component 102 via a direct connection, or via a communication network with which the template generation manager component 102 and the device(s), data store, or other data source can be connected (e.g., via respective wireless or wireline communication connections). In accordance with various embodiments, the template generation manager component 102 (e.g., respective components of the template generation manager component 102) can be part of one or more devices.

A device can be, for example, a computer, a laptop computer, a server, a data storage system or device, a wireless, mobile, or smart phone, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device.

In accordance with various embodiments, to facilitate desirable processing of log messages and generation of log message templates, the template generation manager component 102 can comprise and employ a number of components, comprising an expression processor component 108, a tokenizer component 110, an encoder component 112, a token sequence processor component 114, an AI component 116, a detector component 118, a template generator component 120, and a recovery component 122. In accordance with various embodiments, the AI component 116 can comprise or be associated with the generator model 106, the discriminator model 104, a trainer component 124, a loss determinator component 126, and an update component 128 (e.g., a feedback, update, and/or parameter manager component). In accordance with various embodiments, the generator model 106 and/or the discriminator model 104 can comprise or can be associated with the loss determinator component and/or the update component (e.g., the generator model 106 and/or the discriminator model 104 each can comprise its own loss determinator component and/or update component, or can share a loss determinator component and/or update component). In accordance with various embodiments, the template generation manager component 102 can comprise a data store 130 and a processor component 132 (as depicted in FIG. 1), or can be associated with (e.g., communicatively connected to) the data store 130 and the processor component 132.

In accordance with various embodiments, the generator model 106 and the discriminator model 104 can be AI-based models (e.g., AI, machine learning (ML), neural network, or other type of AI-based models). In certain embodiments, the template generation manager component 102 can employ a model (e.g., a single model architecture) that can comprise a generator model component (e.g., the generator model 106) and a discriminator model component (e.g., the discriminator model 104) associated with (e.g., communicatively connected to) the generator model component, such as described herein. In other embodiments, the generator model 106 and the discriminator model 104 can be separate models, wherein the generator model 106 can be associated with (e.g., communicatively connected to) the discriminator model 104. In some embodiments, the generator model 106 and the discriminator model 104, or the model comprising the generator model component and the discriminator model component, can comprise a transformer-based modeling architecture, such as described herein. For example, the discriminator model 104 can comprise a transformer-based discriminative modeling architecture.

The disclosed subject matter, employing the template generation manager component 102, the generator model 106, the discriminator model 104, and the techniques, methods, processes, and algorithms described herein, can be different from, and can provide enhanced performance with regard to extracting log message templates from log messages (e.g., raw log messages), as compared to existing techniques that can rely heavily on handcrafted rules and labeled data to extract templates from log messages, and other existing techniques, such as LLMs, frequent pattern mining, clustering, log-structure heuristics, longest common subsequence, and evolutionary algorithms, such as described herein. In some embodiments, the disclosed subject matter, employing the template generation manager component 102, the generator model 106, the discriminator model 104, and the techniques, methods, processes, and algorithms described herein can desirably leverage the transformer-based architecture of the discriminator model 104 and generator model 106 with the use of masked language modeling (MLM) techniques by the generator network (e.g., the generator model 106) and the use of TRD techniques by the discriminator network (e.g., the discriminator model 104) to automate dynamic token replacement in log messages (e.g., single-source log messages) to facilitate generating log message templates. Employing the transformer-based architecture, instead of masking the input data (e.g., tokens) alone, the template generation manager component 102 (e.g., employing the token sequence processor component 114) can modify (e.g., change, alter, or corrupt) the input data (e.g., token sequence) by replacing random tokens in the input data with potential or possible tokens that can be sampled from tokens (e.g., predicted tokens) produced by the generator model 106 (e.g., generator network of the generator model 106). The discriminator model 104, employing the TRD technique, can be utilized to predict or infer whether a token in the modified input data (e.g., modified or corrupted token sequence) is a replacement token or not (e.g., is a replacement token, or is an original encoded token associated with the log message). The discriminator model 104 (e.g., the trained discriminator model 104) can utilize the TRD technique to desirably identify (e.g., automatically infer, identify, or detect) whether a token of a sequence of tokens (e.g., representative of a main content portion of a log message) is a dynamic token (e.g., a dynamically changing token (DCT)) or not in the main content portion of the log message. The disclosed subject matter, by reducing or minimizing the use of handcrafted rules, and obviating or mitigating the use of labeled data, desirably can streamline the log message template process, and reduce the complexity and time utilized (e.g., required) for log message analysis, in addition to other advantages and benefits, over existing techniques for log message analysis and log message template generation.

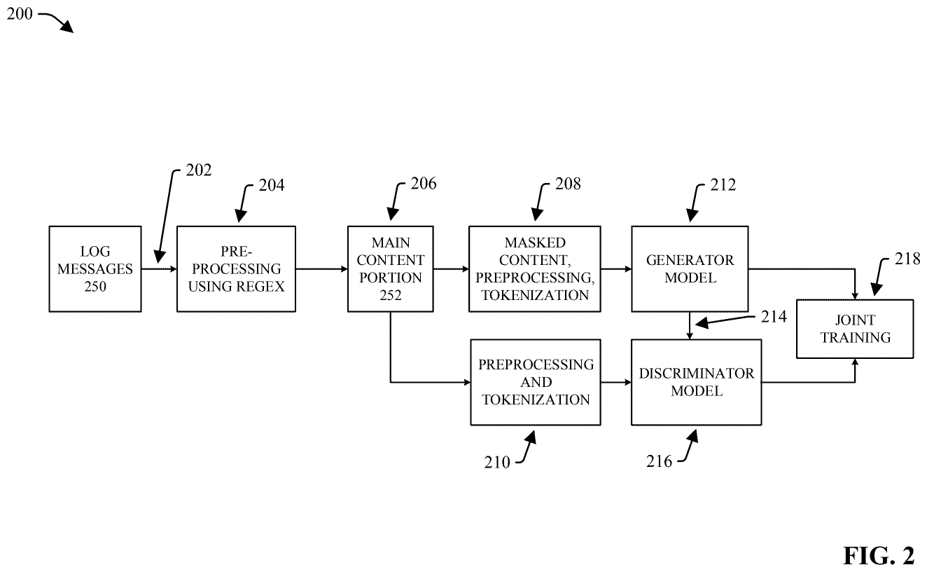

Referring to FIG. 2 (along with FIG. 1), FIG. 2 depicts a block diagram of a non-limiting example process flow 200 that can desirably (e.g., autonomously, automatically, dynamically, suitably, reliably, efficiently, enhancedly, and/or optimally) manage and perform training (e.g., joint training) of the generator model 106 and the discriminator model 104 to facilitate generation of log message templates from log messages, in accordance with various aspects and embodiments of the disclosed subject matter. The example process flow 200 can illustrate respective interactions between respective components of the template generation manager component 102 and/or other components or devices.

As indicated at reference numeral 202 of the example process flow 200, the template generation manager component 102 can receive log messages (e.g., raw log messages) from a desired data source 250, such as a data store, a computer-based system (e.g., server system, storage system, and/or other computer-based system or device), or another desired data source. The log messages can relate to operations, functions, files, file directories, applications, entities, elements, and/or other features of or associated with a computer-based system.

As indicated at reference numeral 204 of the example process flow 200, the template generation manager component 102, employing the expression processor component 108 can perform pre-processing of the information of the log messages using regular expressions (e.g., regex split using regular expressions). As part of the pre-processing of the log messages, with regard to each log message, the expression processor component 108 can utilize (e.g., apply) a group of regular expressions to separate (e.g., divide, split, segment, or distinguish between) respective information elements of the log message based at least in part on the results of analyzing the log message, domain knowledge associated with the log messages and/or computer-based system, the structure of the log message, and the group of regular expressions. As part of the analysis, the expression processor component 108 can identify respective structured information items (e.g., timestamps, log IDs, process IDs, log severity information, and/or other structured information) of the log message utilizing the regular expressions, which can relate to or indicate structured information items of log messages, and, as indicated at reference numeral 206 of the example process flow 200, the expression processor component 108 can separate the respective structured information items from a main content portion 252 of the log message, wherein the main content portion 252 typically, or at least often, can comprise unstructured information items. Unstructured information items can be or can comprise dynamic information items that can be changing over time (e.g., dynamically changing over time), can have an unstructured or varying format, and may not be able to be identified, or at least may be readily or easily be able to be identified, using regular expressions.

For example, a non-limiting example log message can comprise the following information and have the following log message structure: 2023 Feb. 20 14:30:01 ERROR [Thread-1] Failed to connect to database: Connection refused. The expression processor component 108, using the group of regular expressions, can identify and extract the following elements or fields of the log message as follows:
Timestamp: 2023 Feb. 20 14:30:01
Log Level: ERROR
Logger Name: [Thread-1]
Main content portion: Failed to connect to database: Connection refused.
It is to be appreciated and understood that different log messages can have different, and/or more or less, structured information items (e.g., timestamp, log level, logger name) than this example log message, and/or the main content portion can comprise different information than presented in the example log message.

With regard to each of the log messages, the main content portion of the log message can be further processed, such as described herein. For the training of the generator model 106 and discriminator model 104, further log message analysis, and identification of dynamic tokens in log messages, the respective structured information items can be disregarded (e.g., set aside).

As indicated at reference numeral 208 of the example process flow 200, with regard to each of the log messages, the tokenizer component 110 and the encoder component 112 (e.g., of or associated with the tokenizer component 110) can further pre-process, tokenize, and encode the respective main content information items of the main content portion of the log message, and can mask certain content of the respective main content information items, based at least in part on the results of analyzing the main content portion of the log message, using (e.g., applying) a desired encoding and tokenization process to process (e.g., encode and tokenize) the respective main content information items and a desired masking process to mask certain content (e.g., mask certain encoded tokens). Based at least in part on the results of such pre-processing, tokenizing, and encoding, the tokenizer component 110 and/or the encoder component 112 can generate a sequence of encoded tokens that can be representative of the main content information items of the main content portion of the log message. In some embodiments, the tokenizer component 110 and the encoder component 112 can be part of a trained AI-based model that can perform the tokenization and encoding functions and operations on the respective main content information items of respective log messages. In certain embodiments, the trained AI-based model can be or can comprise a generative pre-trained transformer (GPT) model, such as, for example, a second generation GPT (GPT-2) tokenizer, although, in other embodiments, another type of GPT model, another type of trained transformer-based model, another type of trained multimodal large language model, or another type of trained AI-based model, comprising a tokenizer and/or encoder, can be employed by the template generation manager component 102.

In some embodiments, with regard to each of the log messages, the tokenizer component 110 and/or the encoder component 112 (e.g., the trained AI-based model, comprising the tokenizer component 110 and/or the encoder component 112) can tokenize and/or encode the respective main content information items of the log message, based at least in part on the results of analyzing the respective main content information items, using byte pair encoding (BPE), to generate the sequence of encoded tokens. BPE can be a subword segmentation algorithm and process that can be used in natural language processing (NLP) for tokenizing and/or encoding textual data. A primary scheme behind BPE can be to iteratively merge the most frequent pairs of symbols in a sequence to produce a desirably compact representation of the textual data. In some embodiments, pre-trained tokenizer can be utilized, for example, when it is desired to have robust tokenization performance quickly. In certain embodiments, if and as desired, an AI-based tokenizer model can be trained (e.g., by the trainer component 124), for example, when working with domain-specific data, when a custom vocabulary is desired (e.g., wanted or needed), when dealing with certain languages or dialects, and/or when specific tokenization granularity (e.g., fine tokenization granularity) is desired.

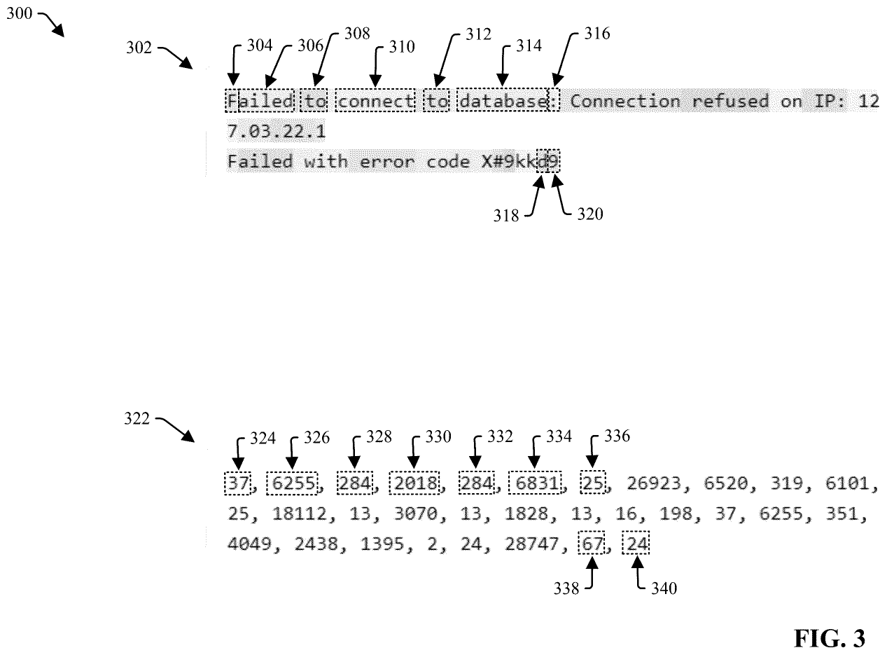

Referring briefly to FIG. 3 (along with FIGS. 1 and 2), FIG. 3 illustrates a diagram of a non-limiting example BPE process 300 that can be performed to encode and tokenize main content information items of a main content portion of a log message to facilitate generating a sequence of encoded tokens that can be representative of the main content information items, in accordance with various aspects and embodiments of the disclosed subject matter. The tokenizer component 110 and/or the encoder component 112 (e.g., employing a GPT-2 tokenizer) can analyze the following example main content portion of an example log message using BPE:
Failed to connect to database: Connection refused on IP: 127.03.22.1
Failed with error code X #9kkd9

Based at least in part on the results of the analysis, the tokenizer component 110 can determine or identify respective words or subwords that can be representative of the main content portion 302 of the log message. The respective words or subwords (e.g., syllables, characters, or symbols) of the main content portion 302 can comprise, for example, “F” 304, “ailed” 306, “to” 308, “connect” 310, “to” 312, “database” 314, “:” 316, up through “d” 318, and “9” 320. Based at least in part on the results of the analysis, the tokenizer component 110 and/or the encoder component 112 can determine and generate respective encoded tokens 322 that can be representative of the respective words or subwords (e.g., words or subwords 304, 306, 308, 310, 312, 314, 316, up through 318 and 320) of the main content portion 302. For example, the tokenizer component 110 and/or the encoder component 112 can determine and generate encoded token 324, encoded token 326, encoded token 328, encoded token 330, encoded token 332, up through encoded token 334 and encoded token 336. Encoded token 324 can have a value (e.g., encoded token value) “37” that can be representative of “F” 304, encoded token 326 can have a value “6255” that can be representative of “ailed” 306, encoded token 328 can have a value “284” that can be representative of “to” 308, encoded token 330 can have a value “2018” that can be representative of “connect” 310, encoded token 332 can have a value “284” that can be representative of “to” 312, encoded token 334 can have a value “6831” that can be representative of “database” 314, encoded token 336 can have a value “25” that can be representative of “:” 316, encoded token 338 can have a value “67” that can be representative of “d” 318, and encoded token 340 can have a value “24” that can be representative of “9” 320. It is to be appreciated and understood that these encoded token values for the respective words or subwords are merely example encoded token values, and different encoded token values can be utilized for the respective words or subwords (e.g., depending on the training, type, and/or structure of the AI-based model employed for the tokenizer component 110 and/or the encoder component 112).

It also is to be appreciated and understood that, while BPE can be employed to tokenize and/or encode the respective main content information items of respective log messages, in other embodiments, the tokenizer component 110 and/or the encoder component 112 (e.g., the trained AI-based model (e.g., whitespace tokenization model, spaCy tokenization model, or other trained AI-based tokenization model), comprising the tokenizer component 110 and/or the encoder component 112) can employ a different type of encoding and tokenization process (e.g., whitespace tokenization, spaCy tokenization, or other type of process) to tokenize and/or encode the respective main content information items of the respective log messages. As a non-limiting example, the tokenizer component 110 and/or the encoder component 112 can employ a whitespace tokenization and/or encoding process that can separate textual data into respective textual terms, based at least in part on detection of white spaces in between the textual terms, and can tokenize and/or encode the respective textual terms.

In some embodiments, as part of the pre-processing of the respective main content information items of the main content portion of the log message described with regard to reference numeral 208, the token sequence processor component 114 can mask certain content (e.g., certain encoded tokens) representative of certain of the respective main content information items to facilitate preparing (e.g., generating) a masked sequence of tokens for input to the generator model 106. For instance, for each log message, there can be a sequence of encoded tokens [x₁, x₂, x₃, . . . , xᵢ, . . . , xₙ] representative of the main content information items of the main content portion of the log message (e.g., as generated by the tokenizer component 110 and/or encoder component 112), wherein xᵢ can be the ith token in the sequence, and n can represent the number of tokens in the sequence. The token sequence processor component 114 can randomly replace a desired portion (e.g., 15%, or another desired portion less than or greater than 15%) of the encoded tokens in the sequence with a masked token [MASK]. For example, with regard to the sequence (e.g., original sequence) of encoded tokens [x₁, x₂, x₃, . . . , xᵢ, . . . , xₙ], the token sequence processor component 114 can select randomly positions, m=[m1, . . . , mₖ] in the sequence to insert masked tokens, where k=0.15 of n, and can replace the encoded tokens in the randomly selected positions of the sequence with the masked tokens to generate a masked sequence of tokens, [x₁, [MASK], x₃, x₄, . . . , [MASK]], that can comprise the respective remaining encoded tokens (e.g., remaining original encoded tokens) and respective masked tokens (e.g., masked tokens that replaced encoded token, x₂, and encoded token, xₙ). In certain embodiments, the token sequence processor component 114 can generate, or can employ a random number generator to generate, random numbers that can be utilized to facilitate selecting random positions of the sequence (e.g., to randomly select the respective positions of the sequence that can correspond to the respective randomly generated numbers).

The masked sequence of tokens can be input into the generator model 106 (e.g., by the token sequence processor component 114, trainer component 124, or another component of the template generation manager component 102), wherein, for example,

$${x}_{masked} = {f}_{replace} ( x , m , [ MASK ] )$$

$${m}_{i} \sim unif \{ 1 , n \} for i = 1 to k ,$$

wherein this function (e.g., x_{masked}=f_{replace} (x,m,[MASK])) can take the input token sequence x (e.g., original token sequence) and replace the encoded tokens at positions specified by m with the masked token (e.g., [MASK]), wherein x can represent the original input token sequence or text, m can represent a mask and can indicate the positions within the input token sequence that are to have encoded tokens replaced with masked tokens, [MASK] can be a special or defined token that can be used in place of certain tokens in the input token sequence to create a prediction challenge for the generator model 106, mᵢ can represent individual elements within the mask m, unif{1, n} can represent or indicate that each position m; can be sampled from a uniform distribution over the range {1, 2, . . . , n}, and for i=1 to k can indicate that k positions can be selected to mask within the token sequence.

In some embodiments, as indicated at reference numeral 210 of the example process flow 200, with regard to each of the log messages, the pre-processing, tokenizing, and encoding of the respective main content information items of the main content portion of the log message also can be performed (e.g., by the tokenizer component 110 and the encoder component 112) for input to the discriminator model 104, based at least in part on the results of analyzing the main content portion of the log message, using (e.g., applying) a desired encoding and tokenization process to process (e.g., encode and tokenize) the respective main content information items, wherein the sequence of encoded tokens generated by such pre-processing, tokenizing, and encoding can be provided to (e.g., input to) the discriminator model 104 (e.g., by the token sequence processor component 114, trainer component 124, or another component of the template generation manager component 102) before and/or without masking certain encoded tokens of the sequence.

As indicated at reference numeral 212 of the example process flow 200, the generator model 106, employing MLM, can be trained (e.g., iteratively trained) to predict respective encoded tokens (e.g., respective encoded token values) associated with the respective masked tokens of the masked sequence of tokens (e.g., predict the respective original encoded tokens that had been replaced by the respective masked tokens in the respective positions in the masked sequence), based at least in part on performing an AI-based analysis on the masked sequence of tokens, for each iteration of one or more iterations of training of the generator model 106, in accordance with the defined model management criteria. The generator model 106 can be trained to learn and understand the context and semantics of the log messages by predicting the original encoded tokens (e.g., of the original sequence) that were replaced by masked tokens in the masked sequence. This understanding of the context and semantics of the log messages by the generator model 106 can be desirable (e.g., wanted, useful, significant, or beneficial) for differentiating between static (and/or structured) and dynamic parts of the log messages. Some of the benefits of training the generator model 106 learn and understand the context and semantics of the log messages can include, for example, improved language understanding, learning contextual knowledge, learning token relationships, and generalized learning. With regard to language understanding, the generator model 106 can develop an enhanced and deeper understanding of the language and its nuances. With regard to contextual knowledge, the generator model 106 can learn to use context to disambiguate tokens that may have multiple meanings. Fine tuning (as part of training) the generator model 106 using the log message data can aid the generator model 106 in learning the typical structure and vocabulary of the log messages. Regarding token relationships, through the training, the generator model 106 can learn the relationships between respective tokens of a token sequence, including synonyms, antonyms, hyponyms, and/or other types of token relationships. With regard to generalized learning, the generator model 106 does not have to be trained or utilized with labeled data. The generator model 106 can use the context (e.g., associated with the tokens, as learned, inferred, or determined by the generator model 106) to predict the respective original encoded tokens that had been replaced by the respective masked tokens in the masked sequence, which can enable the generator model 106 to adapt to the specific data (e.g., specific data of the log messages). By training the generator model 106 on a relatively large corpus of textual data (e.g., a relatively large corpus of log messages), the generator model 106 can be trained to become proficient in predicting tokens in various contexts, which can be desirable (e.g., wanted, beneficial, or essential) for the log message template generation and/or extraction task.

During each training iteration, as part of predicting the original encoded tokens (e.g., including determining and generating predicted tokens that can be a prediction of the encoded token that was replaced by a masked token) for each masked position in the masked sequence, the generator model 106 can determine respective probabilities (e.g., respective probability values) for generating respective tokens at respective positions of the masked sequence. For instance, for a given position t of the masked sequence, the generator model can determine (e.g., calculate) and generate, as an output, a probability p_{G} (xₜ|x) for generating a token xₜ, in accordance with the following non-limiting example equation, as follows:

$${p}_{G} ( {x}_{t} \vert x ) = \frac{exp ( {e ( {x}_{t} )}^{T} {{h}_{G} ( x )}_{t} )}{{\sum }_{{x}^{′}} exp ( {e ( {x}^{′} )}^{T} {{h}_{G} ( x )}_{t} )}$$

wherein p_{G}(xₜ|x) can represent the probability that the generator model 106 can assign to the token xₜ at position t given the entire input token sequence x. With regard to exp(e(xₜ)^{T}h_{G}(x)ₜ), e(xₜ)^{T} can be the embedding vector for the token xₜ where T can be the transpose, and h_{G}(x)ₜ can be the contextualized vector representation at position t, or can be the hidden state vector produced by the generator model 106 for the token at position t. With regard to e(x′)^{T}h_{G} (x)ₜ, this can determine (e.g., calculate) the dot product between the embedding vector and the hidden state, which can measure the alignment or similarity between the predicted token embedding and the context. Regarding exp(e(x′)^{T}h_{G}(x)ₜ), the exponentiating (e.g., exp) of the dot product can scale the similarity measure into a positive value. With regard to Σ_{x′}exp(e(x′)^{T}h_{G}(x)ₜ), this can be a normalization term that can sum over all possible tokens x′ in the vocabulary. This can ensure that the probabilities for all possible tokens xₜ sum to 1, making p_{G}(xₜ|x) a valid probability distribution. Thus, the generator model 106 can assign probabilities p_{G}(xₜ|x) to tokens for positions where the input token sequence has been masked. These probabilities can be determined (e.g., computed by the generator model 106) using the dot product between the token embeddings and the hidden states of the generator model 106, and normalized using a SoftMax function. The discriminator model 104 can evaluate these predicted tokens against the original encoded tokens, and, based at least in part on the results of such evaluation, can determine a loss that can guide both the generator model 106 and the discriminator model 104, such as described herein.

During each training iteration, the loss determinator component 126 can determine (e.g., calculate) the loss (e.g., the amount of loss or error) between the predicted token (e.g., associated with the masked token) and the original encoded token, with respect to each masked token, in accordance with the following non-limiting example equation:

$${L}_{MLM} ( x , {θ}_{G} ) = E [ {\sum }_{i ∈ m} - log {p}_{G} ( {x}_{i} \vert {x}_{masked} ) ]$$

wherein L_{MLM} (x,θ_{G}) can be the loss function for the MLM task. In this loss function equation, x can represent the input sequence of tokens that can be input to the generator model 106, θ_{G} can represent the parameters of the generator model 106 G, E[ . . . ] can denote the expected value, which can mean taking the average over all possible masking patterns and input token sequences. Also, in this loss function equation, Σ_{i∈m} can be the summation over all positions i in the mask set m. The mask set m can contain indices of the tokens in the input token sequence x that have been replaced with the masked token (e.g., [MASK]). Further, in this loss function equation, with regard to −log p_{G}(xᵢ|x_{masked}), p_{G} (xᵢ|x_{masked}) can be the probability that the generator model 106 assigns to the original encoded token xᵢ at position i given the masked input token sequence x_{masked}, log can be the natural logarithm of the probability, which can be used to convert the probabilities into log probabilities, and −log can be the negative log, which can convert the probability into a loss. This can be common in cross-entropy loss, where higher probabilities (e.g., closer to 1) can result in lower loss.

Thus, L_{MLM} (x,θ_{G}) can represent the loss function that can be utilized to facilitate training the generator model 106. The loss function can involve masked tokens where masked tokens can be in randomly selected positions in the input token sequence x to be masked, forming the masked input token sequence x_{masked}. The generator model 106 G, parameterized by θ_{G}, can predict the probabilities p_{G}(xᵢ|x_{masked}) for the masked positions of the masked input token sequence. For each masked position i in the masked input token sequence, the loss determinator component 126, using the loss function equation, can determine (e.g., calculate) the negative log-probability of the original encoded token xᵢ, given the masked token sequence. The loss determinator component 126, using the loss function equation, can sum these probability values to determine or generate the overall loss for a single token sequence. The loss determinator component 126, using the loss function equation, can determine an expectation E over masking patterns such that the expectation E can indicate averaging this process over multiple masking patterns to ensure robustness. This approach and the disclosed techniques can encourage the generator model 106 to assign high probabilities to the original encoded tokens at masked positions, thereby enabling the generator model 106 to learn to generate accurate token replacements that the discriminator model 104 D can evaluate.

During each training iteration, based at least in part on the amount of loss associated with the predicted token(s) associated with the masked token(s), the update component 128 (or the trainer component 124 or other component of the AI component 116) can determine an update (e.g., modification or adjustment) to one or more parameters of a group of parameters (e.g., hyperparameter or other parameters) associated with the generator model 106 that can mitigate (e.g., reduce or minimize) the amount of loss (e.g., with respect to the current training iteration, and for one or more subsequent training iterations), in accordance with the defined model management criteria. The update component 128 can update (e.g., modify or adjust) the one or more parameters associated with the generator model 106 (e.g., to set the parameters associated with the generator model 106 for the next training iteration), based at least in part on the update (e.g., update information of the update), to mitigate the amount of loss associated with the token predictions by the generator model 106. The trainer component 124 can perform one or more additional iterations of training of the generator model 106 (e.g., individually, or in conjunction with iterations of training of the discriminator model 104 (e.g., as part of joint training)), for example, until the defined model management criteria is satisfied (e.g., until a defined accuracy criterion (of the defined model management criteria) indicating that the generator model is desirably accurate in predicting tokens has been satisfied (e.g., met or exceeded), or until a defined model training stopping criterion (of the defined model management criteria) is satisfied.

As indicated at reference numeral 214 of the example process flow 200, the generator model 106 can communicate the output data (e.g., generated by the generator model 106), via the token sequence processor component 114, which can further process the output data, such as described herein, to the discriminator model 104 to facilitate training the discriminator model 104. The output data can comprise information relating to the respective probabilities for generating the respective tokens at respective positions of the masked sequence (e.g., information relating to the respective predicted tokens associated with the respective masked tokens). In some embodiments, a predicted token, as a prediction of an original encoded token, can be the candidate predicted token of a group of candidate predicted tokens that has the highest probability as compared to other probabilities associated with the other candidate predicted tokens of the group of candidate predicted tokens. In some embodiments, the token sequence processor component 114 can generate a modified sequence of tokens, based at least in part on some of the original tokens and the predicted tokens, that can be provided to (e.g., input to) the discriminator model 104. For instance, with regard to the original sequence of encoded tokens (e.g., [x₁, x₂, x₃, . . . , xᵢ, . . . , xₙ]) and the masked sequence of tokens, the token sequence processor component 114 can replace the masked tokens and/or another token(s) (e.g., an encoded token(s)) of the masked sequence with the predicted tokens generated by the generator model 106 (e.g., during the current or corresponding training iteration) to generate the modified (e.g., altered or corrupted) sequence of tokens that can provide the remaining original encoded tokens (which have not been replaced) and the predicted tokens in the respective positions of the modified sequence of tokens. In some instances, a particular predicted token, if an accurate prediction, may match (e.g., may be the same) as the original encoded token, and, in other instances, a particular predicted token, if not an accurate prediction, may not match the original encoded token that had been replaced.

In certain embodiments, to facilitate training of the discriminator model 104, the encoder component 112 (e.g., employing a label encoder) can associate (e.g., can encode) respective labels (e.g., respective label information) with respective tokens of the modified sequence of tokens. For each token, the label associated therewith can indicate whether the token is an original encoded token (e.g., label=0) or a replacement token (e.g., label=1). It is to be appreciated and understood that, if and as desired, different label values than those disclosed above can be utilized to indicate whether the token is an original encoded token or a replacement token.

As disclosed, the modified sequence of tokens and the respective labels associated with the respective tokens of the modified token sequence can be input into the discriminator model 104. The modified token sequence can be encoded and tokenized using the encoder component 112 and/or tokenizer component 110, using the desired encoding and tokenization process (e.g., BPE or other desired process), such as described herein. In some embodiments, to facilitate training the discriminator model 104, the trainer component 124 (or the token sequence processor component 114, the encoder component 112, or other component of the template generation manager component 102) can input the modified token sequence and the respective labels into the discriminator model 104 in accordance with the following non-limiting example equations:

$${\hat{x}}_{l} \sim {p}_{G} ( {x}_{i} \vert {x}_{masked} ) for i ∈ m$$

$${x}_{corrupt} = {f}_{replace} ( x , m , {\hat{x}}_{l} )$$

wherein, with regard to \tilde{x}ₗ˜p_{G} (xᵢ|x_{masked}) for i∈m, \hat{x}ₗ can represent the token generated (or sampled) by the generator model 106 for position i in the token sequence, ˜ can be a symbol that can mean “sampled from” or “distributed according to,” p_{G} (xᵢ|x_{masked}) can be the probability distribution given by the generator model 106 G over possible tokens for the position i, conditioned on the masked version of the input token sequence x_{masked}, and i∈m can indicate that under consideration are the token positions i that are in the set m, which can contain the indices of the masked tokens. With regard to the equation x_{corrupt}=f_{replace}(x,m,\tilde{x}ₗ), x_{corrupt} can be the corrupted version of the original input token sequence x (e.g., can be the modified token sequence), and the f_{replace} (x,m,\tilde{x}ₗ) function can take the original token sequence x, the mask positions m, and the generated tokens \hat{x}ₗ to produce x_{corrupt}. Specifically, the token sequence processor component 114, using the f_{replace}(x,m,\tilde{x}ₗ) function, can replace the tokens in the original encoded token sequence x at positions m with the corresponding tokens from \tilde{x}ₗ.

To further illustrate the process, the token sequence processor component 114 can select (e.g., randomly select) certain positions in the input token sequence x to be masked, which can result in x_{masked}. This typically can be done (e.g., the token sequence processor component 114) by replacing chosen tokens with the masked token (e.g., [MASK]). The generator model 106 G can be utilized to predict or generate tokens for these masked positions based at least in part on the masked token sequence x_{masked}. For each masked position i∈m, a token can be sampled (e.g., by the generator model 106) from the probability distribution p_{G}(xᵢ|x_{masked}) of the generator model 106. The token sequence processor component 114, using the f_{replace}(x,m,\tilde{x}ₗ) function, can take the original encoded token sequence x, the mask positions m, and the generated tokens ft (e.g., the predictions from the generator model 106), and can create the corrupted version of the token sequence x_{corrupt} (e.g., modified token sequence) based at least in part on the original encoded token sequence, the mask positions, and the generated tokens. This corrupted token sequence can have some of the original encoded tokens replaced with the predicted tokens, generated by the generator model 106, at the masked positions. One of the tasks of the discriminator model 104 can be to distinguish between the tokens in the corrupted token sequence x_{corrupt} that match the original encoded tokens in x and those tokens that have been replaced by the samples (e.g., predicted tokens) of the generator model 106, such as described herein. The goal can be to have the discriminator model 104 correctly identify which tokens are original encoded tokens and which tokens are generated by the generator model 106. The techniques, processes, and equations described herein can facilitate improving the ability of the generator model 106 to predict accurate tokens (e.g., in relation to original encoded tokens) and the overall understanding of the language by the generator model 106.

In some embodiments, the discriminator tasks of the discriminator model 104 can comprise training the discriminator model 104 to infer or detect (e.g., perform inferential detection of) whether a token in the modified sequence of tokens is a replacement token or not (e.g., is a predicted token that replaced an original encoded token, or is the original encoded token). A goal of such training of the discriminator model 104 can be for the discriminator model 104 to learn to identify dynamic tokens (e.g., phone numbers, IP addresses, or other type of dynamic information items) that can be replaced with a defined mark (e.g., symbol or character, such as, for example “<*>”) when represented in the log message template, wherein the replacement tokens of the modified token sequence can correlate or be aligned with dynamic tokens associated with a log message for which a log message template is being generated. Thus, an objective of the discriminator model 104 can be that the discriminator model 104 be designed and trained to infer, identify, or detect whether a token associated with a log message has been replaced or altered, which can be directly aligned with the goal of detecting dynamic tokens in log messages.

As indicated at reference numeral 216 of the example process flow 200, the discriminator model 104, employing TRD, can be trained (e.g., iteratively trained) to infer, predict, or detect, and can infer, predict, or detect, whether respective tokens of the modified sequence of tokens are replacement tokens or not (e.g., are predicted tokens (which replaced original encoded tokens) or are original encoded tokens), based at least in part on performing an AI-based analysis on the modified sequence of tokens and the respective labels associated with the respective tokens of the modified token sequence, for each iteration of one or more iterations of training of the discriminator model 104, in accordance with the defined model management criteria. For instance, based at least in part on the results of performing the AI-based analysis on the modified sequence of tokens and the respective labels, the discriminator model 104 can determine (e.g., calculate) respective probabilities (e.g., respective probability values) that the respective tokens of the modified sequence of tokens are a replacement token or an original encoded token, to facilitate inferring or predicting whether the respective tokens are a replacement token or an original encoded token. In some embodiments, based at least in part on the results of performing the AI-based analysis on the modified sequence of tokens and the respective labels, the discriminator model 104 (D) can infer or predict, for a given position t of the modified token sequence, whether a token xₜ of the modified token sequence is real (e.g., an original encoded token (or non-dynamic token)) or not using a sigmoid output layer, as follows:

$$D ( x , t ) = σ ( {w}^{T} {{h}_{D} ( x )}_{t} )$$

wherein can be the contextualized vector representation at position from the discriminator model 104.

The discriminator model 104 (D) can be trained to determine (e.g., calculate) and generate, and can determine and generate, as an output (e.g., as output information), a probability pᵣₑₐₗ (xₜ) that a token xₜ at position t in the log message is real (e.g., comes from the actual data distribution, rather than being generated (e.g., by the generator model 106)). Accordingly, the probability that a token is dynamic (or fake (e.g., not a real token)) can be p_{dynamic} (xₜ)=1−pᵣₑₐₗ (xₜ). If the discriminator model 104 or the detector component 118 determines that the probability (e.g., p_{dynamic} (xₜ)) that a token is dynamic satisfies a defined threshold probability (e.g., τ) relating to (e.g., indicative of) whether a token is dynamic or not, the discriminator model 104 or the detector component 118 can infer or determine that the token xₜ is a dynamic token. For example, if the discriminator model 104 or the detector component 118 determines that the p_{dynamic} (xₜ)>τ, the discriminator model 104 or the detector component 118 can infer or determine that the token xₜ is a dynamic token. If, instead, the discriminator model 104 or the detector component 118 determines that the probability that a token is dynamic does not satisfy the defined threshold probability (e.g., p_{dynamic} (xₜ)≤τ), the discriminator model 104 or the detector component 118 can infer or determine that the token xₜ is not a dynamic token.

During each training iteration, the loss determinator component 126 can determine (e.g., calculate) the amount of loss (e.g., L_{Disc}) or error between the respective probabilities that the respective tokens are replacement tokens (e.g., corrupted tokens) and the respective true labels (e.g., label indicating whether a token is a replacement token or original encoded token) associated with the respective tokens of the modified token sequence, in accordance with the following equation:

$${L}_{Disc} ( x , {θ}_{D} ) = E [ \text{} {\sum }_{t = 1}^{n} - 1 ( {x}_{corrupt , t} = {x}_{t} ) log D ( {x}_{corrupt} , t ) - 1 ( {x}_{corrupt , t} \neq {x}_{t} ) log ( 1 - D ( {x}_{corrupt} , t ) ) ]$$

wherein L_{Disc} (x,θ_{D}) can represent the loss function for the discriminator model 104 (e.g., the discriminator in the model), x can be the original input sequence of encoded tokens, and OD can represent the parameters of the discriminator model 104 D. In this loss function equation, E[ . . . ] can denote the expected value, wherein E[ . . . ] can take the average over various input token sequences and masking patterns, which can ensure that the loss function can be robust across different scenarios. In this loss function equation, with regard to −1(x_{corrupt,t}=xₜ)log D(x_{corrupt},t), 1(x_{corrupt,t}=xₜ) can be an indicator function that can equal 1 if the corrupted token x_{corrupt},t at position t is the same as the original encoded token xₜ, and can be equal to 0 otherwise; and log D(x_{corrupt},t) can be the log probability assigned by the discriminator model 104 to the event that the token at position t is the original encoded token, wherein the discriminator model 104 D can output the probability that a given token is not replaced. In this loss function equation, with regard to −1(x_{corrupt,t}≠xₜ)log(1−D(x_{corrupt},t), 1(x_{corrupt,t}≠xₜ) can be an indicator function that can equal 1 if the corrupted token x_{corrupt},t at position t is different from the original encoded token xₜ, and can be equal to 0 otherwise; and log(1−D(x_{corrupt},t)) can be the log probability assigned by the discriminator model 104 to the event that the token at position is a replacement (e.g., not the original encoded token), wherein the discriminator model 104 can output the probability that a given token is replaced, so 1−D(x_{corrupt},t) can be the probability that the token is a replacement. Thus, as disclosed, L_{Disc}(x,θ_{D}) can be the loss function that can be utilized to facilitate the training of the discriminator model 104 (e.g., facilitate the training of the discriminator in the model). The loss function can measure how well the discriminator model 104 can identify whether each token in the corrupted token sequence is an original encoded token or a replacement token (e.g., predicted token that was a replacement in the token sequence). The loss can be determined (e.g., computed) as the log-probability of correct identification of the token, averaged over multiple token sequences and masking patterns.

To further illustrate aspects of the training of the discriminator model 104 and the loss function equation that can be employed for the discriminator model 104, the token sequence processor component 114 can partially mask the original encoded token sequence x to create the masked token sequence x_{masked}, and the generator model 106 G (e.g., employing or in conjunction with the token sequence processor component 114) can fill the masked positions to create the corrupted token sequence x_{corrupt} (e.g., the modified token sequence). The discriminator model 104 can be trained to distinguish between the original encoded tokens and the predicted tokens (e.g., generated by the generator model 106 G) in the corrupted token sequence. For each token position t, if the token in the corrupted token sequence x_{corrupt} is the same as the original encoded token xₜ, the discriminator model 104 can or should assign a high probability D(x_{corrupt},t), and the loss term −log D(x_{corrupt},t) can be minimized in this case; and, if the token in the corrupted token sequence x_{corrupt} is the not the same as the original encoded token xₜ, the discriminator model 104 can or should assign a low probability 1−D(x_{corrupt},t), and the loss term log(1−D(x_{corrupt},t)) can be minimized in this case. The total loss can be the sum of the loss contributions from all positions in the token sequence. The total loss can indicate how well the discriminator model 104 can differentiate between original encoded tokens and replaced tokens (e.g., predicted tokens that were replacements in the token sequence). The expectation E[ . . . ] can ensure that the loss can be averaged over different masking patterns and input token sequences, which can make the discriminator model 104 robust to various input token sequences.

During each training iteration, based at least in part on the amount of loss (e.g., L_{Disc}) between the respective probabilities and the respective true labels, the update component 128 (or the trainer component 124 or other component of the AI component 116) can determine an update (e.g., modification or adjustment) to one or more parameters of a group of parameters (e.g., hyperparameter or other parameters) associated with the discriminator model 104 that can mitigate (e.g., reduce or minimize) the amount of loss (e.g., with respect to the current training iteration, and for one or more subsequent training iterations), in accordance with the defined model management criteria. The update component 128 can update (e.g., modify or adjust) the one or more parameters associated with the discriminator model 104 (e.g., to set the parameters associated with the discriminator model 104 for the next training iteration), based at least in part on the update (e.g., update information of the update), to mitigate the amount of loss associated with the token inferences or predictions by the discriminator model 104. The trainer component 124 can perform one or more additional iterations of training of the discriminator model 104 (e.g., individually, or in conjunction with iterations of training of the generator model 106 (e.g., as part of joint training)), for example, until the defined model management criteria is satisfied (e.g., until a defined accuracy criterion (of the defined model management criteria) indicating that the discriminator model 104 is desirably accurate in predicting tokens has been satisfied (e.g., met or exceeded), or until a defined model training stopping criterion (of the defined model management criteria) is satisfied.

In some embodiments, the trainer component 124 can periodically or dynamically update or refine (e.g., further train) the training of the generator model 106 and discriminator model 104. For instance, the trainer component 124 can periodically (e.g., weekly, monthly, quarterly, or at another desired period) update or refine the training of the generator model 106 and discriminator model 104, using the techniques described herein. Additionally or alternatively, the trainer component 124 can dynamically (e.g., in response to an event, such as a software or firmware update that relates to or impacts log messages (e.g., changes in log message format or log message entities)) update or refine the training of the generator model 106 and discriminator model 104, using the techniques described herein.

The advantages and benefits of such training and use of the discriminator model 104 can include, for example, improved accuracy as the discriminator model 104 can become increasingly accurate in detecting replaced tokens, which can lead to or result in enhanced log message template extraction; robustness to variations, as the discriminator model 104 can learn to handle and adapt to variations in token replacement, which can improve the robustness of the discriminator model 104; and contextual understanding, as the discriminator model 104 can develop a deeper understanding of the context in which tokens are used, which can improve the ability of the discriminator model 104 to detect replacement tokens. By training the discriminator model 104 on a relatively large corpus of labeled data, the discriminator model 104 can be trained to become proficient in detecting (e.g., inferentially detecting) replaced tokens, which can be desirable (e.g., wanted, beneficial, or essential) for desirably accurate for log message template generation and/or extraction.

In some embodiments, the generator model 106 and the discriminator model 104 can be combined such that they can be part of the same AI-based model, and/or the generator model 106 and the discriminator model 104 can be jointly trained (e.g., trained jointly, concurrently, or simultaneously in conjunction with each other), as indicated at reference numeral 218 of the example process flow 200, wherein the generator model 106 (or generator model component) and the discriminator model 104 (or discriminator model component) can be jointly trained, using the disclosed techniques, such as described herein. In some embodiments, as part of the joint training, the trainer component 124, the loss determinator component 126, the update component 128, and/or another component of the template generation manager component 102 can work and/or coordinate to determine respective enhancements (e.g., improvements or adjustments) that can be made to the respective parameters of the generator model 106 and the discriminator model 104, using the techniques and functions described herein, to facilitate enhancing (e.g., improving, increasing, or optimizing) the respective performance of the generator model 106 and the discriminator model 104 with regard to performing their respective tasks (e.g., generator tasks and discriminator tasks), in accordance with the defined model management criteria.

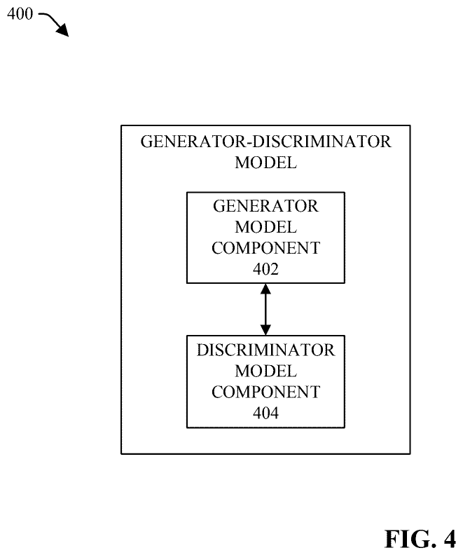

Referring briefly to FIG. 4 (along with FIGS. 1 and 2), FIG. 4 depicts a block diagram of a non-limiting example generator-discriminator model 400 that can perform generator tasks and discriminator tasks to facilitate log message template generation and/or extraction, in accordance with various aspects and embodiments of the disclosed subject matter. The generator-discriminator model 400 can comprise a generator model component 402 that can correspond to and/or perform the same or similar functions as the generator model 106, and a discriminator model component 404 that can correspond to and/or perform the same or similar functions as the discriminator model 104, wherein the generator model component 402 can be associated with (e.g., communicatively connected to) the discriminator model component 404. The generator model component 402 and the discriminator model component 404 can be jointly (e.g., concurrently or simultaneously) trained, using the techniques and functions described herein.

The generator-discriminator model 400, by combining the generator model functions and the discriminator model functions into the single model, can provide enhanced understanding by the model 400, enhanced multi-task learning, shared tokenizing and/or encoding of data, task-specific heads, and joint training. For instance, with regard to enhanced understanding, using the generator model component 402 can first aid the generator-discriminator model 400 build (e.g., construct or develop) a strong understanding of the contexts of the log messages. This foundational knowledge regarding context can be desirably leveraged by the discriminator model component 404 to infer, identify, or detect dynamic tokens in log messages more accurately. Regarding multi-task learning, the trainer component 124 can train a single generator-discriminator model 400 on both the generator tasks of the generator model component 402 and the discriminator tasks of the discriminator model component 404 concurrently or simultaneously, wherein knowledge gained by the generator model component 402, the discriminator model component 404, and/or the AI component 116 (e.g., trainer component 124, loss determinator component 126, or update component 128) through performance of the respective generator tasks and respective discriminator tasks can be shared by the generator model component 402, the discriminator model component 404, and/or the AI component 116 between tasks.

With regard to shared tokenizing and/or encoding of data, the generator model component 402 and the discriminator model component 404 of the generator-discriminator model 400 can utilize a shared tokenizer component 110 and/or shared encoder component 112 (e.g., shared GPT-2 tokenizer model or other trained AI-based tokenizer model) to tokenize and/or encode data to generate encoded tokens. Regarding task-specific heads, the generator-discriminator model 400 can comprise task-specific heads (e.g., generator model component 402 and discriminator model component 404) for the respective tasks (e.g., generator tasks and discriminator tasks), which can be utilized to determine (e.g., compute) or facilitate determining the respective task-specific losses associated with the performance of the respective tasks. With regard to joint training, the generator-discriminator model 400 can be trained on both generator tasks and discriminator tasks jointly, with a combined loss function that can include the MLM loss associated with the generator model component 402 and the TRD loss associated with the discriminator model component 404. For example, the loss determinator component 126 can determine (e.g., calculate) the combined loss function in accordance with (e.g., using) the following non-limiting example equation:

$${min}_{{θ}_{G} , {θ}_{D}} {\sum }_{x ∈ X} {L}_{MLM} ( x , {θ}_{G} ) + λ {L}_{Disc} ( x , {θ}_{D} ) .$$

wherein λ can be a desired value, and wherein the other respective terms can be such as defined or described herein.

The update component 128 can utilize the combined loss function to determine an update that can be made to respective parameters associated with the generator-discriminator model 400 (e.g., respective updates that can be made to respective parameters associated with the generator model component 402 and the discriminator model component 404) to facilitate mitigating (e.g., reducing or minimizing) the combined loss function to enhance training and performance of the generator-discriminator model 400 (e.g., during a subsequent iteration(s) of training of the model 400), in accordance with the defined model management criteria.

By combining the generator tasks and the discriminator tasks into the single generator-discriminator model 400, the generator-discriminator model 400 can leverage the strengths of both the generator tasks and the discriminator tasks to improve performance of the generator-discriminator model 400. Performance of the generator tasks by the generator-discriminator model 400 (e.g., the generator model component 402) can aid the model 400 in learning the context and relationships between tokens of a sequence of tokens associated with (e.g., representative of) a log message, and performance of the discriminator tasks by the generator-discriminator model 400 (e.g., the discriminator model component 404) can aid the model 400 in learning to infer and/or detect (e.g., inferentially detect) replaced tokens in a token sequence associated with the log message.

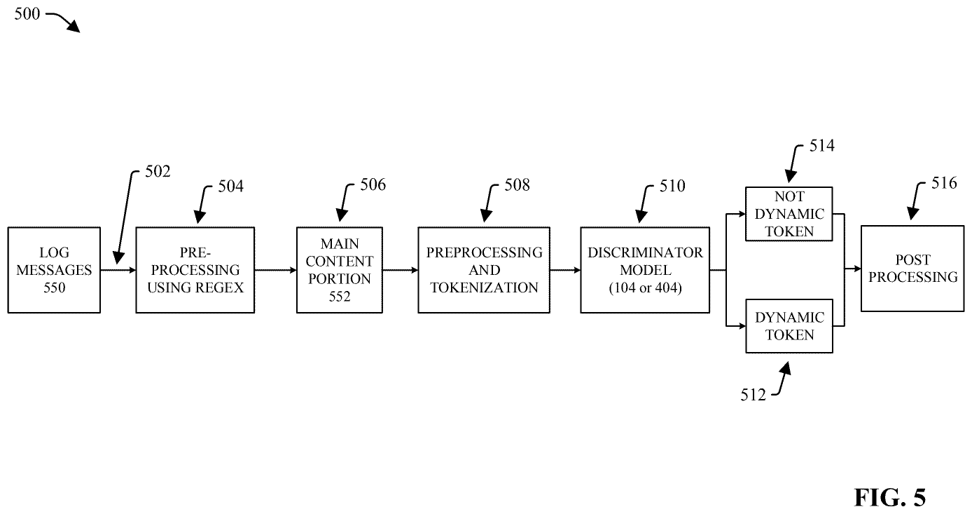

Referring to FIG. 5 (along with FIGS. 1 and 4), FIG. 5 illustrates a block diagram of a non-limiting example process flow 500 that desirably (e.g., automatically, dynamically, suitably, reliably, efficiently, enhancedly, and/or optimally) can be utilized to generate log message templates from log messages using a trained discriminator model, in accordance with various aspects and embodiments of the disclosed subject matter. The example process flow 500 can illustrate respective interactions between respective components of the template generation manager component 102, the trained discriminator model (e.g., trained discriminator model 104 or trained generator-discriminator model 400), and/or other components or devices.

As indicated at reference numeral 502 of the example process flow 500, the template generation manager component 102 can receive one or more log messages (e.g., one or more raw log messages) from a desired data source 550, such as a data store, a computer-based system (e.g., server system, storage system, and/or other computer-based system or device), or another desired data source. The log messages can relate to operations, functions, files, file directories, applications, entities, elements, and/or other features of or associated with a computer-based system.

As indicated at reference numeral 504 of the example process flow 500, with regard to each log message, the expression processor component 108 can perform pre-processing of the information of the log message using regular expressions (e.g., regex split using regular expressions). As part of the pre-processing of the log message, the expression processor component 108 can utilize the group of regular expressions to separate respective information elements of the log message based at least in part on the results of analyzing the log message, domain knowledge associated with the log messages and/or computer-based system, the structure of the log message, and the group of regular expressions, such as described herein. As part of the analysis, the expression processor component 108 can identify respective structured information items of the log message utilizing the regular expressions, which can relate to or indicate structured information items of log messages, and, as indicated at reference numeral 506 of the example process flow 500, the expression processor component 108 can separate the respective structured information items from a main content portion 552 of the log message, wherein the main content portion 552 typically, or at least often, can comprise unstructured information items. In some embodiments, with regard to each of the one or more log messages, respective upper case characters of the main content information items of the main content portion of the log message can be converted to respective lower case characters, such as described herein. In certain embodiments, with regard to each of the one or more log messages, the main content portion of the log message can be further processed, such as described herein. For further log message analysis and identification of dynamic tokens in log messages, the respective structured information items of the log messages can be disregarded (e.g., set aside, at least until generation of the log message templates of such log message).

As indicated at reference numeral 508 of the example process flow 500, with regard to the log message, the tokenizer component 110 and the encoder component 112 (e.g., the trained AI-based tokenizer model) can further pre-process, tokenize, and encode the respective main content information items of the main content portion of the log message, based at least in part on the results of analyzing the main content portion of the log message, using (e.g., applying) a desired encoding and tokenization process to process (e.g., encode and tokenize) the respective main content information items. Based at least in part on the results of such pre-processing, tokenizing, and encoding, the tokenizer component 110 and/or the encoder component 112 can generate a sequence of encoded tokens that can be representative of the main content information items of the main content portion of the log message. In some embodiments, the tokenizer component 110 and the encoder component 112 can be part of a trained AI-based model (e.g., the trained AI-based tokenizer model), such as described herein.

As indicated at reference numeral 510 of the example process flow 500, the trained discriminator model (e.g., trained discriminator model 104, or the discriminator model component 404 of the trained generator-discriminator model 400), employing TRD, can infer, predict, or detect, whether respective encoded tokens of the sequence of encoded tokens are dynamic tokens 512 (e.g., unstructured and/or varying tokens) or not dynamic tokens 514, based at least in part on performing an AI-based analysis on the sequence of encoded tokens, such as described herein. For instance, with regard to each token of the token sequence associated with the main content portion of the log message, the trained discriminator model (and/or the detector component 118) can infer, predict, or detect, whether the encoded token is a dynamic token 512 or is not a dynamic token 514, based at least in part on performing an AI-based analysis on the sequence of encoded tokens, such as described herein. For example, with regard to each encoded token of the token sequence, the trained discriminator model can determine whether the probability (e.g., p_{dynamic} (xₜ)) that the encoded token is dynamic satisfies (e.g., exceeds) the defined threshold probability (e.g., t) relating to (e.g., indicative of) whether an encoded token is dynamic or not, such as described herein. If the trained discriminator model 104 determines that the probability satisfies the defined threshold probability, the trained discriminator model 104 can infer or determine that the encoded token is a dynamic token 512. If, instead, the trained discriminator model determines that the probability does not satisfy the defined threshold probability, the trained discriminator model can infer or determine that the encoded token is not a dynamic token 514.

As indicated at reference numeral 516 of the example process flow 500, with regard to each log message, the template generation manager component 102 can perform post processing on the log message, including utilizing the respective inferences or determinations, by the trained discriminator model (and/or the detector component 118), regarding whether the respective encoded tokens of the token sequence are dynamic tokens 512 or not dynamic tokens 514, to generate a log message template that can be representative of the log message. For instance, with regard to each log message, the template generator component 120 can generate a log message template that can be representative of the log message, wherein the template generator component 120 can replace one or more dynamic information items (e.g., as represented by one or more dynamic tokens) in the log message with one or more defined marks (e.g., defined symbols or defined characters, such as, for example, “<*>”, or another desired mark). In some embodiments, the template generator component 120 can generate the log message template associated with the log message such that the log message template can comprise the respective structured information items in respective positions of the log message template that can correspond to the respective positions of the respective structured information items in the log message, and, with regard to the main content portion of the log message, the log message template can comprise the respective main content information items, which were determined to not be dynamic information items, in the respective positions of the main content portion of the log message template that can correspond to the respective positions of those respective main content information items in the main content portion of the log message, and can comprise the one or more respective defined marks (e.g., representative of the one or more respective dynamic information items) in the respective positions of the main content portion of the log message template that can correspond to the respective positions of the one or more respective dynamic information items in the log message.

The template generator component 120 can store the log message templates in a data store 130 of or associated with the template generation manager component 102. In certain embodiments, the template generation manager component 102 can make the log message templates (e.g., generated by the template generation manager component 102 and/or stored in the data store 130) available (e.g., if and when authorized or permitted) to a device and/or user (e.g., an authenticated and/or authorized device and/or user) for analysis of such log message templates and/or for other authorized uses.

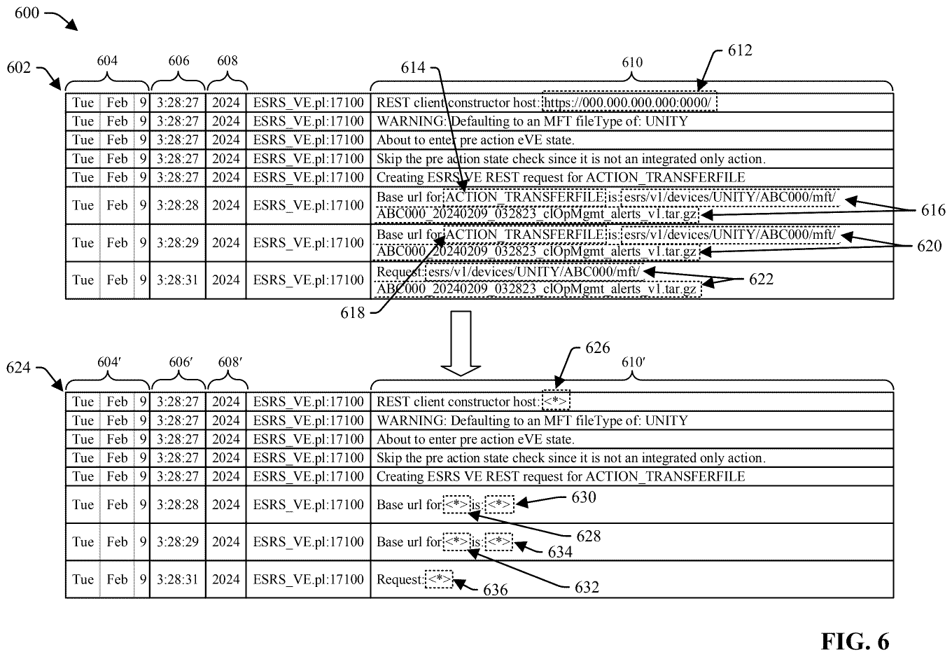

Turning briefly to FIG. 6 (along with FIGS. 1, 4, and 5), FIG. 6 presents a diagram of a log message template generation 600, in accordance with various aspects and embodiments of the disclosed subject matter. The template generation manager component 102 can receive a log message 602 that can comprise raw log message data. The expression processor component 108 can perform pre-processing of the information of the log message 602 using regular expressions, such as described herein. As part of the pre-processing, the expression processor component 108 can separate respective information elements of the log message based at least in part on the results of analyzing the log message 602, domain knowledge associated with the log message 602 and/or computer-based system, the structure of the log message 602, and the regular expressions. As part of the analysis, the expression processor component 108 can identify respective structured information items, such as date items 604, time items 606, year items 608, and/or other structured information of the log message 602 utilizing (e.g., applying) the regular expressions, and can identify the main content portion 610 of the log message 602. The expression processor component 108 can separate the respective structured information items (e.g., 604, 606, and 608) from the main content portion 610 of the log message 602, wherein the main content portion 610 typically, or at least often, can comprise unstructured information items, some of which may be dynamic information items.

The tokenizer component 110 and the encoder component 112 (e.g., of or associated with the tokenizer component 110) can further pre-process, tokenize, and encode the respective main content information items of the main content portion 610 of the log message 602, based at least in part on the results of analyzing the main content portion 610 of the log message 602, using (e.g., applying) a desired encoding and tokenization process (e.g., BPE). Based at least in part on the results of such pre-processing, tokenizing, and encoding, the tokenizer component 110 and/or the encoder component 112 can generate a sequence of encoded tokens that can be representative of the main content information items of the main content portion 610 of the log message 602. The template generation manager component 102 can input the sequence of encoded tokens into the trained discriminator model (e.g., trained discriminator model 104, or the discriminator model component 404 of the trained generator-discriminator model 400).

The trained discriminator model, employing TRD, can infer, predict, determine, or detect, whether respective encoded tokens of the sequence of encoded tokens are dynamic tokens or not dynamic tokens, based at least in part on performing an AI-based analysis on the sequence of encoded tokens, such as described herein. In this example scenario, with regard to the log message 602, the trained discriminator model can infer or detect that the respective encoded tokens associated with (e.g., representative of) main content information items 612, 614, 616, 618, 620, and 622 (e.g., dynamic information items) of the main content portion 610 of the log message 602 can be dynamic tokens, and the other encoded tokens of the token sequence can be inferred or determined to be non-dynamic tokens by the trained discriminator model.

The template generator component 120 can generate a log message template 624 that can be representative of the log message 602, wherein the template generator component 120 can replace dynamic tokens associated with the log message 602 with respective defined marks (e.g., defined symbols or defined characters, such as, for example, “<*>”, or another desired mark) as part of the generation of the log message template 624. For instance, the template generator component 120 can replace the respective dynamic information items (e.g., main content information items 612, 614, 616, 618, 620, and 622), as represented by one or more dynamic tokens, of the log message 602 with the respective defined marks (e.g., “<*>”) such that the log message template 624 can comprise the respective defined marks (e.g., the defined marks <*> 626, 628, 630, 632, 634, and 636) in the respective positions (e.g., locations) of the respective dynamic information items in the log message template 624. In some embodiments, as part of the generation of the log message template 624, the template generator component 120 can generate the log message template 624 such that the log message template 624 also can comprise the respective structured information items (e.g., 604′, 606′, and 608′) in respective positions of the log message template 624 that can correspond to the respective positions of the respective structured information items (e.g., 604, 606, and 608) in the log message 602, and, with regard to the main content portion 610 of the log message 602, the log message template 624 can comprise the respective main content information items, which were determined to not be dynamic information items, in the respective positions of the main content portion 610′ of the log message template 624 that can correspond to the respective positions of those respective main content information items in the main content portion 610 of the log message 602, and can comprise the one or more respective defined marks (e.g., the defined marks <*> 626, 628, 630, 632, 634, and 636) in the respective positions of the main content portion 610′ of the log message template 624 that can correspond to the respective positions of the one or more respective dynamic information items (e.g., main content information items 612, 614, 616, 618, 620, and 622) in the log message 602. As desired, the log message template 624 can be stored in the data store 130 and/or can be provided to a user or device for further analysis or other desired use.

In some embodiments, the template generation manager component 102 can employ the recovery component 122 to recover the original dynamic information items of the log message for which a log message template has been generated. In some instances, it can be desired by a user or a device to recover the replaced information (e.g., dynamic information items) of a log message that was replaced by defined marks in a log message template. One of the desirable aspects of the disclosed subject matter is that the original information (e.g., dynamic information items) of a log message is not deleted from the log message during generation of a corresponding log message template, which can be representative of the log message and can have dynamic information items of the log message removed and replaced by defined marks. In certain embodiments, if it is desired to recover replaced information items (e.g., dynamic information items) associated with a log message template that comprises defined marks in place of the replaced information items, the recovery component 122 can analyze (e.g., compare) the log message template and the original log message, and, based at least in part on such analysis results, can generate recovery output information that can be representative of the original log message, including the dynamic information items that were replaced by the defined marks.

As an example, an original log message can comprise the following information items (e.g., in the main content portion of the log message):
User logged in from IP address 192.168.0.1 at 12:34 PM
User logged out from IP address 192.168.0.2 at 12:40 PM
Admin accessed system from IP address 10.0.0.1 at 14:15 PM.

Using the models and the techniques described herein, the template generation manager component 102 can generate the following log message template (e.g., portion of log message template relating to the main content portion of the log message) that can be representative of the log message, but with defined marks (e.g., “<*>” or other desired defined mark) in place of the dynamic information items detected by the template generation manager component 102 during the log message template generation process:
User logged in from IP address <*> at <*> PM
User logged out from IP address <*> at <*> PM
Admin accessed system from IP address <*> at <*> PM.

In some embodiments, if and as desired, the recovery component 122 can recover the dynamic information items of the log message that were replaced by the defined marks, based at least in part on the results of analyzing (e.g., comparing) the log message template and the original log message. For instance, based at least in part on the analysis results, the recovery component 122 can generate the following non-limiting example recovery output information that can be representative of the original log message, including the dynamic information items that were replaced by the defined marks, as follows:

| | |
|---|---|
| User logged in from IP | [192.168.0.1, 12:34] |
| address <*> at <*> PM | |
| User logged out from IP | [192.168.0.2, 12:40] |
| address <*> at <*> PM | |
| Admin accessed system from | [10.0.0.1, 14:15] |
| IP address <*> at <*> PM | |

The following is a non-limiting example of training of the generator model 106 and the discriminator model 104 (or the training of the generator-discriminator model 400), and utilizing the trained discriminator model 104 (or the trained generator-discriminator model 400) to facilitate generation of a log message template associated with a log message. An original log message can comprise the following respective main content information items (e.g., in the main content portion of the log message):
User logged in from IP address 192.168.0.1 at 12:34 PM
User logged out from IP address 192.168.0.2 at 12:40 PM
Admin accessed system from IP address 10.0.0.1 at 14:15 PM

The tokenizer component 110 and the encoder component 112 can tokenize and encode the respective main content information items, based at least in part on the results of analyzing the main content information items, using a desired encoding and tokenization process. For illustration purposes, and ease of understanding, in this example instance, whitespace tokenization can be employed (instead of the BPE process), wherein, with whitespace tokenization, the respective main content information items can be structured or distinguished as follows as part of the whitespace tokenization process.
[‘User’, ‘logged’, ‘in’, ‘from’, ‘IP’, ‘address’, ‘192.168.0.1’, ‘at’, ‘12:34’, ‘PM’]
[‘User’, ‘logged’, ‘out’, ‘from’, ‘IP’, ‘address’, ‘192.168.0.2’, ‘at’, ‘12:40’, ‘PM’]
[‘Admin’, ‘accessed’, ‘system’, ‘from’, ‘IP’, ‘address’, ‘10.0.0.1’, ‘at’, ‘14:15’, ‘PM’]
As part of this example encoding and tokenization process (e.g., employing whitespace tokenization), the tokenizer component 110 and the encoder component 112 can generate respective encoded tokens that can be representative of the respective main content information items, with a portion of the values of the encoded tokens presented as follows.
[12982, 18832, 287, 422, 6101, 2209, . . . ]
[12982, 18832, 503, 422, 6101, 2209, . . . ]
[46787, 17535, 1080, 422, 6101, 2209, . . . ]
For instance, with regard to the first line of the main content portion of the log message, 12982 can represent ‘User’, 18832 can represent ‘logged’, 287 can represent ‘in’, 422 can represent ‘from’, 6101 can represent ‘IP’, and 2209 can represent ‘address’.

The token sequence processor component 114 can randomly replace some of the encoded tokens with masked tokens in randomly selected position of the original encoded token sequence to generate a masked sequence of respective tokens, comprising some of the original encoded tokens and some masked tokens, such as described herein. In this example scenario, the token sequence processor component 114 can randomly replace some of the encoded tokens with masked tokens as follows.
[‘[MASK]’, ‘logged’, ‘in’, ‘from’, ‘IP’, ‘address’, ‘[MASK]’, ‘at’, ‘12:34’, ‘PM’]
[‘User’, ‘logged’, ‘[MASK]’, ‘from’, ‘IP’, ‘address’, ‘192.168.0.2’, ‘at’, ‘[MASK]’, ‘PM’]
[‘Admin’, ‘[MASK]’, ‘system’, ‘from’, ‘IP’, ‘[MASK]’, ‘10.0.0.1’, ‘at’, ‘14:15’, ‘PM’]

The trainer component 124 can input the masked sequence of respective tokens into the generator model 106 to train the generator model 106 (e.g., to initially or at least partially train the generator model 106). The generator model 106 can perform an AI-based analysis on the masked sequence of respective tokens. Based at least in part on the results of such AI-based analysis, the generator model 106 can be trained (e.g., at least partially trained) and can generate respective predictions of at least some of the respective tokens of the masked token sequence, including respective predicted tokens that can be respective predictions of the respective original encoded tokens that were replaced by the masked tokens, such as described herein. For instance, the respective predictions of the generator model 106 with regard to the example masked sequence of tokens can be as follows, wherein, for illustration purposes, and case of understanding, such predictions are shown in word form, rather than encoded token value form, wherein “*” can indicate the predicted tokens that are predicted by the generator model, and wherein the tokens without “*” can be original encoded tokens that were part of the masked token sequence.
[‘User’*, ‘logged’, ‘in’, ‘from’, ‘IP’, ‘address’, ‘198.51.100.1’*, ‘at’, ‘19:34’*, ‘PM’]
[‘User’, ‘logged’, ‘out’*, ‘from’, ‘IP’, ‘address’, ‘198.51.100.1’*, ‘at’, ‘19:40’*, ‘PM’]
[‘Admin’, ‘accessed’*, ‘system’, ‘from’, ‘IP’, ‘address’*, ‘12.0.0.1’*, ‘at’, ‘16:15’*, ‘PM’]
As can be observed from the prediction results, when compared to the original main content information items, the generator model 106 predicted ‘User’, ‘out’, ‘accessed’, and ‘address’ correctly, but ‘198.51.100.1’, ‘19:34’, ‘198.51.100.1’, ‘19:40’, ‘12.0.0.1’, and ‘16:15’ can be predictions that do not match the original encoded tokens (e.g., are incorrect predictions).

The prediction results from the generator model 106 can be utilized to facilitate training the discriminator model 104. The discriminator model 104 can receive as input the original sequence of encoded tokens, which for illustration purposes and case of understanding are shown in word form, rather than encoded token values, as follows.
[‘User’, ‘logged’, ‘in’, ‘from’, ‘IP’, ‘address’, ‘192.168.0.1’, ‘at’, ‘12:34’, ‘PM’]
[‘User’, ‘logged’, ‘out’, ‘from’, ‘IP’, ‘address’, ‘192.168.0.2’, ‘at’, ‘12:40’, ‘PM’]
[‘Admin’, ‘accessed’, ‘system’, ‘from’, ‘IP’, ‘address’, ‘10.0.0.1’, ‘at’, ‘14:15’, ‘PM’]

The token sequence processor component 114 can modify the masked token sequence by replacing the masked tokens and/or some of the encoded tokens in the masked token sequence with the corresponding predicted tokens that were predicted by the generator model 106 to generate a modified sequence of respective tokens, comprising some of the original encoded tokens and the predicted tokens (e.g., as replacement tokens) in respective positions of the modified sequence of respective tokens, such as described herein. In this example scenario, the token sequence processor component 114 can replace the masked tokens and some of the encoded tokens in the masked token sequence with the corresponding predicted tokens to generate the example modified sequence of respective tokens as follows, wherein, again, for illustration purposes and case of understanding, the tokens are shown in word form, rather than encoded token values, wherein “*” can indicate the predicted tokens (also referred to as replacement tokens) that were predicted by the generator model 106, and wherein the tokens without “*” can be original encoded tokens that were part of the masked token sequence.
[‘User’*, ‘logged’, ‘in’, ‘from’, ‘IP’, ‘address’, ‘198.51.100.1’*, ‘at’, ‘19:34’*, ‘PM’]
[‘User’, ‘logged’, ‘out’*, ‘from’, ‘IP’, ‘address’, ‘198.51.100.1’*, ‘at’, ‘19:40’*, ‘PM’]
[‘Admin’, ‘accessed’*, ‘system’, ‘from’, ‘IP’, ‘address’*, ‘12.0.0.1’*, ‘at’, ‘16:15’*, ‘PM’]

The trainer component 124 can input the modified sequence of respective tokens into the generator model 106 to train the discriminator model 104 (e.g., to initially or at least partially train the discriminator model 104). The discriminator model 104 can perform an AI-based analysis on the modified sequence of respective tokens to facilitate training of the discriminator model 104 and to facilitate inferring, predicting, detecting, or determining whether each of the respective tokens of the modified sequence is a replacement token or not. Based at least in part on the results of such AI-based analysis, the discriminator model 104 can be trained (e.g., at least partially trained) and can determine and generate respective probabilities that the respective tokens of the modified sequence are replacement tokens or not, and/or respective inferences, predictions, detections, or determinations that the respective tokens of the modified sequence are replacement tokens or not, such as described herein. In this example scenario, the discriminator model 104 can infer or detect (e.g., inferentially detect) that the following tokens (presented in word form, rather, than token value form, for illustration purposes and ease of understanding) of the modified token sequence are replacement tokens.
192.168.0.1->198.51.100.1 (replaced)
192.168.0.2->198.51.100.1 (replaced)
10.0.0.1->12.0.0.1 (replaced)
12:34->19:34 (replaced)
12:40->19:40 (replaced)
14:51->16:15 (replaced)

As can be observed, the discriminator model 104 identified all of the prediction tokens in the modified token sequence that were replacement tokens and had incorrect predicted token values as compared to the corresponding original encoded tokens. While ‘User’, ‘out’, ‘accessed’, and ‘address’ also were predicted tokens/replacement tokens, these predicted tokens had correct predicted token values, and thus, had the same token values as the corresponding original encoded tokens. It therefore can be desirable that the discriminator model 104 does not infer or determine that such correctly predicted tokens are replacement tokens, particularly given that training of the discriminator model 104 can be intended for the discriminator task of inferring and/or detecting dynamic information items (e.g., dynamic tokens) in log messages.

After the discriminator model 104 has been trained, the trained discriminator model 104 can be employing, during the inference phase, to infer or detect whether respective encoded tokens of a token sequence, which can be representative of a main content portion of a subsequent log message, are dynamic tokens or not, based at least in part on the results of performing an AI-based analysis of the token sequence. For instance, there can be an example new log message that can have a main content portion as follows:
User logged in from IP address 172.16.0.1 at 09:45 AM.

The tokenizer component 110 and the encoder component 112 can tokenize and encode the respective main content information items of the main content portion, based at least in part on the results of analyzing the main content information items, using a desired encoding and tokenization process. For illustration purposes, and case of understanding, in this example instance, whitespace tokenization can be employed (instead of the BPE process), wherein, with whitespace tokenization, the respective main content information items can be structured or distinguished as follows as part of the whitespace tokenization process.
[‘User’, ‘logged’, ‘in’, ‘from’, ‘IP’, ‘address’, ‘172.16.0.1’, ‘at’, ‘09:45’, ‘AM’]
As part of this example encoding and tokenization process (e.g., employing whitespace tokenization), the tokenizer component 110 and the encoder component 112 can generate a token sequence comprising respective encoded tokens that can be representative of the respective main content information items, with a portion of the values of the encoded tokens presented as follows.
[12982, 18832, 287, 422, 6101, 2209, . . . ]
For instance, 12982 can represent ‘User’, 18832 can represent ‘logged’, 287 can represent ‘in’, 422 can represent ‘from’, 6101 can represent ‘IP’, and 2209 can represent ‘address’.

The token sequence comprising the respective encoded tokens can be input into the trained discriminator model 104. The trained discriminator model 104 can perform an AI-based analysis on the sequence of respective tokens to facilitate inferring, predicting, detecting, or determining whether each of the respective tokens of the sequence is a dynamic token or not. Based at least in part on the results of such AI-based analysis, the discriminator model 104 can determine and generate respective probabilities that the respective tokens of the token sequence are dynamic tokens or not.

For instance, in this example scenario, the discriminator model 104 can determine and generate respective probabilities (e.g., pᵣₑₐₗ (xₜ)) that the respective encoded tokens are not dynamic tokens (e.g., are real tokens) as follows:
‘User’: 0.99;
‘logged’: 0.98;
‘in’: 0.97;
‘from’: 0.98;
‘IP’: 0.99;
‘address’: 0.97;
‘192.16.0.1’: 0.20;
‘at’: 0.99;
‘07:45’: 0.10; and
‘AM’: 0.98.
Accordingly, the trained discriminator model 104 (or the detector component 118) can determine (e.g., calculate) respective probabilities (e.g., p_{dynamic} (xₜ)) that the respective encoded tokens are dynamic tokens as follows:
‘User’: 0.01;
‘logged’: 0.02;
‘in’: 0.03;
‘from’: 0.02;
‘IP’: 0.01;
‘address’: 0.03;
‘192.16.0.1’: 0.80;
‘at’: 0.01;
‘07:45’: 0.90; and
‘AM’: 0.02.

In this example scenario, the template generation manager component 102 and/or a user can set the defined threshold probability (e.g., τ) relating to dynamic token detection at 0.5, wherein encoded tokens with p_{dynamic} (xₜ)>τ can be inferred, determined, and/or flagged to be dynamic tokens (e.g., by the discriminator model 104 or the detector component 118), and wherein encoded tokens with p_{dynamic} (xₜ)≤τ can be inferred or determined to not be dynamic tokens (e.g., by the discriminator model 104 or the detector component 118). In this example scenario, the discriminator model 104 (or the detector component 118) can infer or determine that ‘192.16.0.1’ is a dynamic token (e.g., the encoded token representative of ‘192.16.0.1’ is a dynamic token), since its probability of 0.80 is greater than the defined threshold probability, and can infer or determine that ‘07:45’ is a dynamic token (e.g., the encoded token representative of ‘07:45’ is a dynamic token), since its probability of 0.90 is greater than the defined threshold probability.

The template generation manager component 102 can generate a log message template that can be representative of the log message, wherein the template generator component 120 can replace the dynamic information items (e.g., as represented by the dynamic tokens) in the log message with a defined marks, such as, for example, “<*>”, or another desired mark. For instance, in the part of the log message template relating to the main content information items of the main content portion of the new log message, the template generator component 120 can replace the dynamic tokens representative of ‘192.16.0.1’ and ‘07:45’ as follows:
[‘User’, ‘logged’, ‘in’, ‘from’, ‘IP’, ‘address’, ‘<*>’, ‘at’, ‘<*>’, ‘AM’],
wherein the template generator component 120 can present the main content information items of the main content portion of the new log message, with the dynamic information items replaced by the defined marks, in the log message template, as follows:
User logged in from IP address <*> at <*> AM.

With further regard to the system 100, the template generation manager component 102 can comprise or be associated with (e.g., communicatively connected to) a processor component 132 and the data store 130. The processor component 132 can employ one or more processors (e.g., one or more central processing units (CPUs)), accelerators, graphics processing units (GPUs), application-specific integrated circuits (ASICs), microprocessors, or controllers that can process information relating to data, files, log messages, information items, tokens, dynamic tokens, predicted tokens, predictions, inferences, probabilities, AI-based models, AI-related data, training data, feedback information, update information, parameters (e.g., hyperparameters and other parameters) thresholds values (e.g., threshold probability values or other threshold values), weight values, applications, services, devices, users, resources, data processing operations, messages, notifications, alarms, alerts, preferences (e.g., user or client preferences), hash values, metadata, traffic flows, tables, mappings, policies, defined model management criteria, algorithms (e.g., enhanced model management algorithms, enhanced model training algorithms, enhanced log message template generation algorithms, encoding and tokenization algorithms, hash algorithms, data compression algorithms, data decompression algorithms, and/or other algorithm), interfaces, application programming interfaces (APIs), protocols, tools, and/or other information, to facilitate operation of the template generation manager component 102 and the system 100, and control data flow between the template generation manager component 102 and/or other components (e.g., a computer-based system, a device, a node, an application, a service, a user, the communication network, network equipment or components, or other entity) associated with the template generation manager component 102 and the system 100.

The data store 130 can store data structures (e.g., user data, metadata), code structure(s) (e.g., modules, objects, hashes, classes, procedures) or instructions, information relating to data, files, log messages, information items, tokens, dynamic tokens, predicted tokens, predictions, inferences, probabilities, AI-based models, AI-related data, training data, feedback information, update information, parameters (e.g., hyperparameters and other parameters) thresholds values (e.g., threshold probability values or other threshold values), weight values, applications, services, devices, users, resources, data processing operations, messages, notifications, alarms, alerts, preferences (e.g., user or client preferences), hash values, metadata, traffic flows, tables, mappings, policies, defined model management criteria, algorithms (e.g., enhanced model management algorithms, enhanced model training algorithms, enhanced log message template generation algorithms, encoding and tokenization algorithms, hash algorithms, data compression algorithms, data decompression algorithms, and/or other algorithm), interfaces, application programming interfaces (APIs), protocols, tools, and/or other information, to facilitate controlling or performing operations associated with the template generation manager component 102 and the system 100. The data store 130 can comprise volatile and/or non-volatile memory, such as described herein. In an aspect, the processor component 132 can be functionally coupled (e.g., through a memory bus) to the data store 130 in order to store and retrieve information desired to operate and/or confer functionality, at least in part, to the expression processor component 108, tokenizer component 110, encoder component 112, token sequence processor component 114, AI component 116, detector component 118, template generator component 120, recovery component 122, processor component 132, data store 130, and/or other component of the template generation manager component, and/or substantially any other operational aspects of the template generation manager component and the system 100.

As disclosed, the data store 130 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

With further regard to the AI component 116 and the models, the AI component 116 can perform (e.g., can employ the models (e.g., generator model, discriminator model, or generator-discriminator model) to perform) AI-based analysis on data and generate AI-based analysis results, in accordance with various aspects and embodiments of the disclosed subject matter. The AI component 116 can comprise or be associated with the trainer component 124, and the model(s) (e.g., generator model, discriminator model, or generator-discriminator model). The AI component 116 and/or the model(s) 128 can perform an AI-based analysis on data, such as information relating to log messages, tokens, labels, and/or other types of data, and/or feedback information (e.g., feedback information from a user, a device, or another data source). In some embodiments, with regard to the model(s), the AI component 116 can input such information into the model(s) for analysis by the model(s) to update (e.g., to further train or refine training of) the model(s) or to generate output results (e.g., AI-related data) based at least in part on the analysis of the input information.

In connection with or as part of such an AI-based analysis, the AI component 116 can employ, build (e.g., construct or create), and/or import, AI-based techniques and algorithms, AI-based models, transformer-based models, neural networks, decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining a predicted token that can be a prediction of an original encoded token that was replaced by a masked token, detecting or determining (e.g., inferentially detecting or determining) whether a token is a replacement token or not (e.g., during training of the discriminator model), detecting or determining (e.g., inferentially detecting or determining) whether a token is a dynamic token or not (e.g., by the trained discriminator model), performing other desired functions or operations, and/or automating one or more functions or features of the disclosed subject matter, as more fully described herein.

The AI component 116 and the model(s) (e.g., generator model, discriminator model, or generator-discriminator model) can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 116 and/or the model(s) can examine the entirety or a subset of the data (e.g., the training data; token sequences; label data; the feedback information; operational data; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 116 and/or the model(s) (e.g., generator model, discriminator model, or generator-discriminator model) can employ a classifier that can perform an AI-based analysis on data. A classifier can map an input attribute vector, z=(z1, z2, z3, z4, . . . , zn), to a confidence that the input belongs to a class, as by f(z)=confidence (class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

The disclosed subject matter, by employing the template generation manager component 102, the models, the techniques, methods, and algorithms described herein, desirably can combine generator-discriminator networks to handle dynamically changing tokens and extract log message templates, whereas existing methods can rely on a single technique, such as certain existing generator networks and Multi-objective Log message Format Identification (MoLFI) using evolutionary algorithms. The disclosed subject matter, by employing the template generation manager component 102, the models, the techniques, methods, and algorithms described herein, desirably can advantages due to its dual training objectives (generator (MLM) and discriminator (TRD)) where in this context labeled data does not have to be utilized. In the combination of the generator-discriminator network, the discriminator model, employing TRD, can evaluate whether a text fragment (e.g., a token) is real (e.g., an original encoded token) or generated (e.g., a token generated or predicted by the generator model), which can encourage the generator model (MLM) to produce more realistic and coherent text embeddings beyond simplistic token prediction.

The disclosed subject matter, by employing the template generation manager component 102, the models, the techniques, methods, and algorithms described herein, also desirably can adapt to changing log message patterns without any manual intervention (e.g., by a user). This is one of a number of significant advantages that the disclosed subject matter can have when compared to existing techniques relating to log message template generation.

The disclosed subject matter, by employing the template generation manager component 102, the models, the techniques, methods, and algorithms described herein, also desirably can handle out of vocabulary (OOV) words gracefully and well, as the template generation manager component 102 can segment words into subword units based at least in part on frequency, even if a word is not present in the training data (e.g., token sequences and/or other training data). In some embodiments, the template generation manager component 102, the models, the techniques, methods, and algorithms described herein can handle such cases (e.g., cases involving OOV words) by generating subword representations that can match or substantially match (e.g., can satisfy a defined match or similarity criterion and/or can satisfy (e.g., meet or exceed) a defined threshold match or similarity value with regard to) similar words or parts of the words present in the corpus. The disclosed subject matter, by employing the template generation manager component 102, the models, the techniques, methods, and algorithms described herein, also can effectively compress the overall representation of the words in the log messages by reducing instances where rare or unseen words may have to be explicitly stored.

The disclosed subject matter, by employing the template generation manager component 102, the models, the techniques, methods, and algorithms described herein, further can desirably (e.g., automatically, reliably, efficiently, enhancedly, or optimally) extract log message templates representative of log messages with minimal reliance on hand crafted rules or labeled data, in contrast to existing techniques, such as simple logfile clustering tool (SLCT) that can involve (e.g., require) manual rule engineering and Spell that can involve (e.g., require) labeled data for training. The disclosed subject matter, by employing the template generation manager component 102, the models, the techniques, methods, and algorithms described herein, desirably can utilize less feature engineering steps, as compared to existing techniques for log message template generation, and can produce log message templates with significantly enhanced consistency and accuracy, as compared to existing techniques for log message template generation.

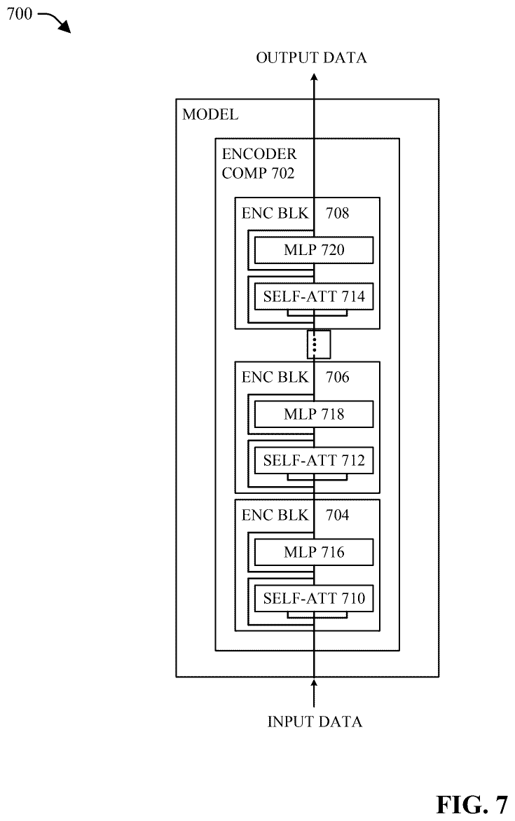

Referring to FIG. 7 (along with FIGS. 1 and 4), FIG. 7 illustrates a block diagram of a non-limiting example model 700 that can comprise a transformer-based architecture (e.g., a transformer-based encoder architecture), in accordance with various aspects and embodiments of the disclosed subject matter. In accordance with various embodiments, the example model 700 can be a generator model, a discriminator model, or generator-discriminator model that can comprise respective functionality, such as described herein.

In some embodiments, the model 700 can employ a transformer-based encoder architecture that can be composed of an encoder component (ENCODER COMP) 702. As disclosed, in accordance with various embodiments, the data input to the encoder component 702 can comprise sequences of tokens (e.g., sequence of encoded tokens, masked sequence comprising encoded tokens and masked tokens, or modified sequence comprising encoded tokens and predicted tokens (e.g., replacement tokens)) and/or labeled data, wherein the type(s) of token sequences that can be input to the encoder component 702 can depend in part on the type of model (e.g., generator model, a discriminator model, or generator-discriminator model) being employed, the type of task (e.g., generator task or discriminator task) being performed by the model 700, the phase (e.g., training phase or inference phase) associated with the model 700 at the time, and/or another factor, and wherein the label data can be provided to the model 700, for example, if and when the model 700 is a discriminator model undergoing training.

The model 700, employing the encoder component 702 can perform, render, or determine various inferences, predictions, probabilities, or determinations in connection with performing various tasks (e.g., generator tasks or discriminator tasks) based at least in part on the results of analyzing (e.g., performing an AI-based analysis) and processing (e.g., encoding) of the input data, such as described herein. It is to be appreciated and understood that the structure of the model 700 and the encoder component 702 are non-limiting example structures of the model 700 and encoder component 702 for illustration purposes, and, in other embodiments, the model 700 and/or the encoder component 702 can be structured differently and/or can comprise different components or configurations than depicted in FIG. 7 and described herein. Also, it is to be appreciated and understood that the respective structures, configurations, and/or components of the model 700 and the encoder component 702 can depend in part on the type of model (e.g., generator model, a discriminator model, or generator-discriminator model) being employed, the types of task (e.g., generator tasks or discriminator tasks) to be performed by the model 700, and/or another factor.

The encoder component 702 can comprise one or more encoder blocks (e.g., transformer encoder sub-components), such as encoder blocks (ENC BLKs) 704, 706, and/or 708, that can be associated with (e.g., communicatively connected to) each other (e.g., the output of encoder block 704 can be associated with the input of encoder block 706, and the output of encoder block 706 can be associated with the input of the next encoder block (e.g., encoder block 708 or another encoder block (if any) situated between the encoder block 706 and encoder block 708). The encoder blocks (e.g., 704, 706, and/or 708) can process or analyze the input data (e.g., sequence(s) of tokens and/or label data), and based at least in part on the results of such processing or analyzing, can render or determine various inferences, predictions, probabilities, or determinations in connection with performance of the various tasks by the model 700.

The encoder blocks (e.g., 704, 706, and/or 708) can comprise multiple layers that each can comprise self-attention and feed-forward neural network layers, such as described herein. In some embodiments, the respective encoder blocks (e.g., 704, 706, and/or 708) of the encoder component 702 each can comprise respective self-attention components (SELF-ATT) (e.g., 710, 712, and/or 714) and respective multi-layer perceptron (MLP) components (e.g., 716, 718, and/or 720) that can be associated with (e.g., communicatively connected to) the respective self-attention components (e.g., 710, 712, and/or 714). The respective self-attention components (e.g., 710, 712, and/or 714) can be or can comprise a desired number of respective self-attention layers that can enable the self-attention components (and the model 700) to determine (e.g., dynamically or automatically determine) the relative importance of respective items of data (e.g., words or subwords) in a sequence of data items (e.g., relative importance of respective tokens of a sequence of tokens), enabling the self-attention components (and thus, the model 700) to capture long-range dependencies in data (e.g., words). For instance, a self-attention component (e.g., 710, 712, or 714) can analyze a group of words (e.g., words, numbers, alphanumeric characters, as represented by tokens) to determine and/or obtain the context of the group of words, which can facilitate processing (e.g., natural language processing) of the sequence of words in the group of words and recognizing those words. As part of the self-attention process, a self-attention component (e.g., 710, 712, or 714) can, for example, assign a query to each word in the group of words (e.g., sentence, phrase, clause, entry (e.g., log message entry or cell), or other group of words), compare the queries associated with the group of words to keys, which can be determined or derived from the words in the group of words, in order to determine or identify the most relevant information with regard to that group of words. The self-attention component can combine the respective items of information from (and as part of) such self-attention process, with the respective items of information being respectively weighted based on their respective relevance, to determine and generate a contextual representation of each of the words in that group of words. In some embodiments, position-based information can be associated with (e.g., added to) the representations of the words in the group of words to facilitate (e.g., enable) the self-attention component understanding or determining the order and arrangement of words in the group of words.

In certain embodiments, the respective self-attention components (e.g., 710, 712, and/or 714) can utilize three matrices, comprising a query matrix, key matrix, and value matrix, that can enable the respective self-attention components to determine, understand, and/or process relationships between words in the group of words. The query matrix can enable focusing on a word of interest in the group of words, the key matrix can determine or measure relevance between words in the group of words, and the value matrix can provide context that can facilitate determining or generating a final or overall contextual representation of the focus word. The query, key, and value matrices can operate together to enable the self-attention component (e.g., 710, 712, or 714) to desirably determine, identify, or capture the respective relationships and dependencies between respective words in the group of words.

With further regard to the query matrix, the query matrix can represent a focus word with regard to which the context is being determined by the self-attention component (e.g., 710, 712, or 714). Based at least in part on the results of analyzing the information relating to the group of words, the self-attention component can utilize the query matrix of the word to transform the word representation, and determine and/or generate a query vector that can be compared with other words in the group of words.

The self-attention component (e.g., 710, 712, or 714) can utilize the key matrix to determine and/or generate key vectors for the words in the group of words, based at least in part on the results of analyzing the information (e.g., tokens and/or other information) relating to the group of words. The self-attention component can utilize the key vectors to determine or measure the relevance or similarity between the focus word (e.g., utilizing the associated query vector) and other words in the group of words. A higher relevance or similarity score between the query vector associated with the focus word and a key vector can indicate a relatively stronger (e.g., a relatively more significant or greater) relationship between the respective (e.g., corresponding) words, whereas, conversely, a relatively lower relevance or similarity score between the query vector and the key vector can indicate a relatively weaker relationship between the respective words.

The self-attention component (e.g., 710, 712, or 714) can utilize the value matrix to determine and/or generate value vectors for the words in the group of words, wherein the respective value vectors can contain the respective contextual information of the respective words. The self-attention component, after determining (e.g., calculating) the respective relevance or similarity scores, based at least in part on the respective query vectors and key vectors, can determine a weighted sum of the value vectors. The self-attention component can determine the weights for each of the value vectors based at least in part on the relevance or similarity scores, which can thereby enable (and/or ensure that) the final or overall contextual representation to be (can be) influenced more by relevant words in the group of words. In some embodiments, as part of the self-attention process, the self-attention component (e.g., 710, 712, or 714) can employ, determine, adjust, and/or apply respective attention weights, such as, for example, query weight, key weight, and value weight, associated with the query component (e.g., query matrix), key component (e.g., key matrix), and the value component (e.g., value matrix), respectively, to facilitate determining, identifying, or capturing the respective relationships and dependencies between respective words in the group of words.

The respective MLP components (e.g., 716, 718, and/or 720) can be or can comprise respective feed-forward layers (e.g., respective feed-forward neural network layers) that can comprise neurons (e.g., fully connected neurons) that can have an activation function (e.g., nonlinear activation function or linear activation function). In some embodiments, the respective MLP components (e.g., 716, 718, and/or 720) can comprise three or more layers (e.g., an input layer, an output layer, and one or more layers (e.g., hidden layers) in between the input layer and the output layer) of nonlinearly activating nodes. For fully connected MLP components, each node in a layer can be associated with (e.g., can connect with a respective weight value to) the nodes in the following layer of the MLP component. In certain embodiments, the respective MLP components (e.g., 716, 718, and/or 720) can be trained and can learn using backpropagation techniques. For instance, in an MLP component (e.g., 716, 718, or 720), learning (e.g., as part of supervised learning) in the perceptron can be performed or can occur by modifying (e.g., adjusting, updating, or changing) connection weights (e.g., between nodes) after each item of data is processed based at least in part on the amount of error determined to be in the output relative to (e.g., as compared to) the expected output (e.g., expected result), wherein the error information can be backpropagated to facilitate the determining and modifying of the connection weights. The respective MLP components (e.g., 716, 718, and/or 720) can receive the respective output data from the respective self-attention components (e.g., 710, 712, and/or 714), analyze and process such respective output data, such as described herein, and transform the respective output data to generate output (e.g., encoded output data) that can be output (e.g., by the output layer of the MLP component) from the encoder component 702. The output from the encoder component 702 can comprise, for example, the various inferences, predictions, probabilities, or determinations that can be rendered by the model 700 (e.g., the encoder component 702 of the model 700) in connection with performance of the various tasks (e.g., generator tasks and/or discriminator tasks) by the model 700, wherein the various inferences, predictions, probabilities, or determinations can be inferences, predictions, probabilities, or determinations, such as described herein with regard to the system 100 and the methods disclosed herein.

It is to be appreciated and understood that one or more components (e.g., the template generation manager component, the models, devices, or other components) of the systems (e.g., the system 100 or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

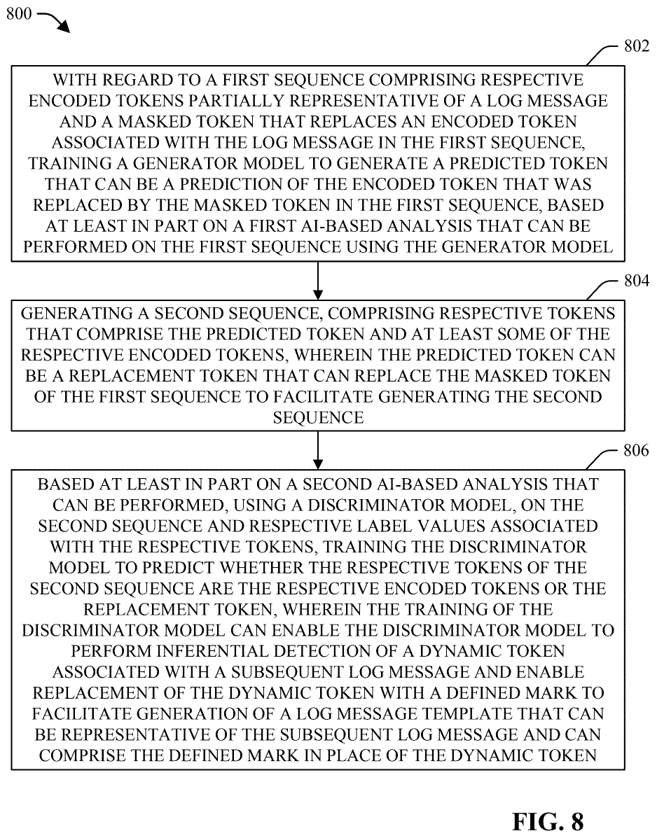

In view of the example systems and/or devices described herein, example methods that can be implemented in accordance with the disclosed subject matter can be further appreciated with reference to flowcharts in FIGS. 8-11. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 8 illustrates a flow chart of an example method 800 that can desirably (e.g., automatically, dynamically, suitably, reliably, efficiently, enhancedly, and/or optimally) train a generator model and a discriminator model to enable the discriminator model to perform inferential detection of a dynamic token associated with a log message and enable replacement of the dynamic token with a defined mark to facilitate generation of a log message template that can be representative of the log message and can comprise the defined mark in place of the dynamic token, in accordance with various aspects and embodiments of the disclosed subject matter. The method 800 can be employed by, for example, a system comprising the template generation manager component, the processor component, the data store, and/or other components, wherein the template generation manager component can comprise various components, such as described herein.

At 802, with regard to a first sequence comprising respective encoded tokens partially representative of a log message and a masked token that replaces an encoded token associated with the log message in the first sequence, a generator model can be trained to generate a predicted token that can be a prediction of the encoded token that was replaced by the masked token in the first sequence, based at least in part on a first AI-based analysis that can be performed on the first sequence using the generator model. For instance, with regard to an original sequence of encoded tokens that can be representative of a main content portion of the log message, the token sequence processor component can alter the original token sequence by randomly replacing one or more of the encoded tokens of the original token sequence with one or more masked tokens to generate the first sequence, which can comprise the respective remaining encoded tokens of the original token sequence and the one or more masked tokens (e.g., the masked token) that can replace the one or more encoded tokens (e.g., the encoded token) associated with the log message in the first sequence. The trainer component can input the first sequence into the generator model and can train the generator model to generate the predicted token, which can be the prediction of the encoded token that was replaced by the masked token as part of generation of the first sequence, based at least in part on first results of the first AI-based analysis that can be performed on the first sequence using the generator model, such as described herein.

At 804, a second sequence, comprising respective tokens that comprise the predicted token and at least some of the respective encoded tokens, can be generated, wherein the predicted token can be a replacement token that can replace the masked token of the first sequence to facilitate generating the second sequence. The token sequence processor component can modify the first sequence to generate the second sequence that can comprise the respective tokens, which can comprise the predicted token and at least some of the respective encoded tokens of the first sequence of tokens, wherein the predicted token can be the replacement token that can replace the masked token of the first sequence to facilitate generating the second sequence, such as described herein.

At 806, based at least in part on a second AI-based analysis that can be performed, using a discriminator model, on the second sequence and respective label values associated with the respective tokens, the discriminator model can be trained to predict whether the respective tokens of the second sequence are the respective encoded tokens or the replacement token, wherein the training of the discriminator model can enable the discriminator model to perform inferential detection of a dynamic token associated with a subsequent log message and enable replacement of the dynamic token with a defined mark to facilitate generation of a log message template that can be representative of the subsequent log message and can comprise the defined mark in place of the dynamic token. For instance, the trainer component can input the second sequence of respective tokens into the discriminator model and can train the discriminator model to predict whether the respective tokens of the second sequence are the respective encoded tokens or the replacement token (e.g., the predicted token), such as described herein.

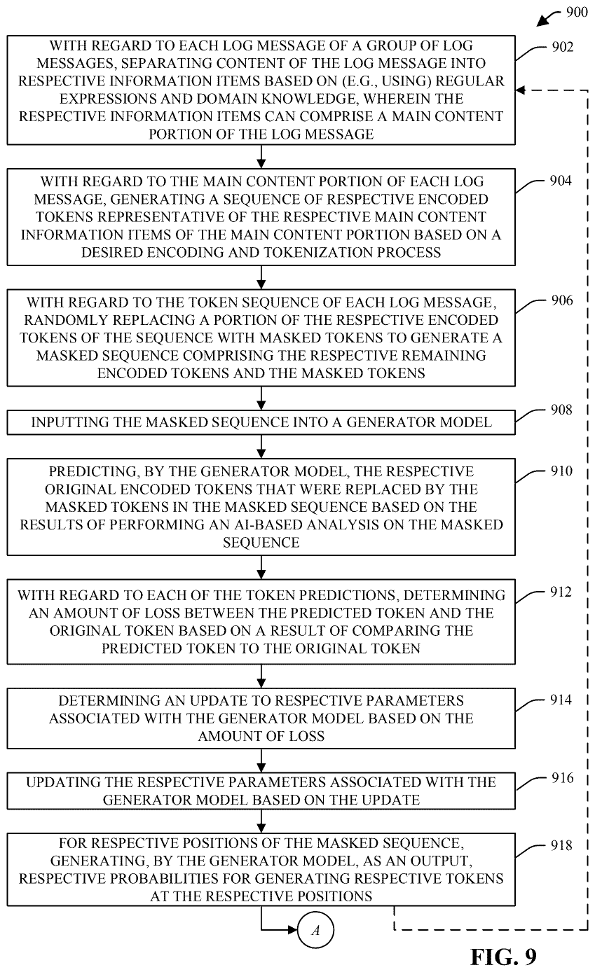

FIG. 9 depicts a flow chart of an example method 900 that can desirably (e.g., automatically, dynamically, suitably, reliably, efficiently, enhancedly, and/or optimally) train a generator model to predict tokens (e.g., predict original encoded tokens of an original token sequence) that were replaced by masked tokens in a masked sequence of tokens associated with a log message, in accordance with various aspects and embodiments of the disclosed subject matter. The method 900 can be employed by, for example, a system comprising the template generation manager component, the processor component, the data store, and/or other components, wherein the template generation manager component can comprise various components, such as described herein.

At 902, with regard to each log message of a group of log messages, content of the log message can be separated into respective information items of the log message based at least in part on (e.g., using) regular expressions and domain knowledge, wherein the respective information items can comprise a main content portion of the log message. The expression processor component can identify (e.g., determine) the respective information items in the content of the log message and can separate (e.g., divide or segment) the content into the respective information items and/or extract the respective information items from the log message based at least in part on the regular expressions and the domain knowledge, wherein the domain knowledge can relate to the group of log messages. In some embodiments, the expression processor component can separate the main content portion, including respective main content information items contained therein, from the other respective information items (e.g., timestamp, severity level, and/or other structured information items) of the log message. The main content portion can be or can comprise unstructured information (e.g., main content information items that may not be associated with regular expressions).

At 904, with regard to the main content portion of each log message of the group of log messages, a sequence of respective encoded tokens representative of the respective main content information items of the main content portion can be generated based at least in part on a desired encoding and tokenization process. In some embodiments, the tokenizer component can encode and tokenize the respective main content information items to generate the sequence of respective encoded tokens using the desired encoding and tokenization process (e.g., BPE or other desired encoding and tokenization process).

At 906, with regard to the sequence of respective encoded tokens of each log message of the group of log messages, a portion of the respective encoded tokens of the sequence can be randomly replaced with masked tokens to generate a masked sequence comprising the respective remaining encoded tokens and the masked tokens. The token sequence processor component can randomly replace a desired portion (e.g., 15% or other desired portion) of the respective encoded tokens (e.g., in respective randomly selected positions of the sequence) with the masked tokens to generate the masked sequence comprising the respective remaining encoded tokens (e.g., of the original token sequence) and the masked tokens, in accordance with the defined masking process (e.g., the defined masking algorithm).

At 908, the masked sequence, comprising the respective remaining encoded tokens and the masked tokens, can be input into a generator model. The AI component, employing the trainer component, can input the masked sequence into the generator model.

At 910, the generator model can predict the respective original encoded tokens that were replaced by the masked tokens in the masked sequence based at least in part on the results of performing an AI-based analysis on the masked sequence comprising the respective remaining encoded tokens and the masked tokens. For instance, the generator model can perform an AI-based analysis on the masked sequence comprising the respective remaining encoded tokens and the masked tokens. Based at least in part on the results of such analysis, the generator model can predict or infer the respective original tokens (e.g., the respective original token values) that were replaced by the masked tokens.

At 912, with regard to each of the token predictions, an amount of loss between the predicted token and the original token can be determined based at least in part on a result of comparing the predicted token to the original token. The AI component, employing the loss determinator component, can determine (e.g., calculate) the amount of loss (e.g., the amount of error) between the predicted token (e.g., predicted token value) and the original token (e.g., original token value) based at least in part on the result of comparing the predicted token to the original token.

At 914, an update to respective parameters associated with the generator model can be determined based at least in part on the amount of loss. For instance, with regard to the respective amounts of loss associated with the respective predicted tokens (e.g., the amount of loss collectively, respective individual amounts of loss associated with the respective predicted tokens, the average amount of loss associated with the predicted tokens, or other loss determination based at least in part on the respective amounts of loss), the AI component, employing the update component, can determine the update to the respective parameters (e.g., hyperparameters and/or other parameters) associated with the generator model to mitigate (e.g., reduce or minimize) the loss (e.g., mitigate the amount of loss associated with the predicted tokens).

At 916, the respective parameters associated with the generator model can be updated based at least in part on the update. The update component can update (e.g., adjust or modify) the respective parameters associated with the generator model to facilitate mitigating the loss associated with the predicted tokens.

At 918, for respective positions of the masked sequence, the generator model can generate, as an output, respective probabilities for generating respective tokens at the respective positions. For instance, for each position t in the masked sequence, the generator model can determine and generate, as the output, the probability for generating the token x, at the position t.

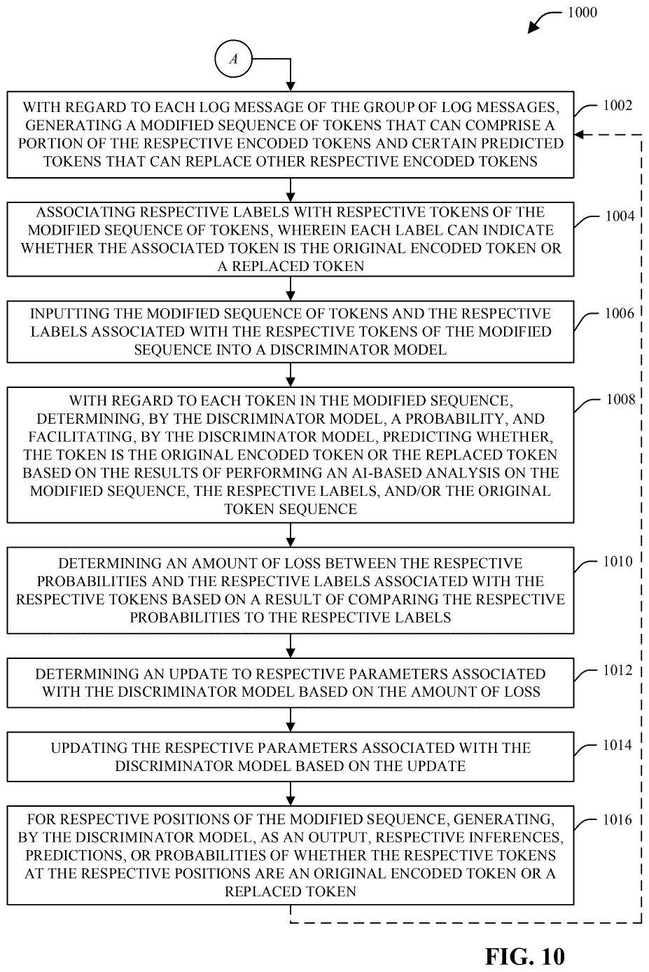

In some embodiments, the method 900 can return to reference numeral 902 to perform one or more additional iterations of training of the generator model, for example, until the defined model management criteria is satisfied (e.g., until a defined accuracy criterion (of the defined model management criteria) indicating that the generator model is desirably accurate in predicting tokens has been satisfied, or until a defined model training stopping criterion (of the defined model management criteria) is satisfied). In certain embodiments, the method 900 can proceed to reference point A, wherein the method 1000 can proceed from reference point A to facilitate training a discriminator model, such as described herein and shown in FIG. 10.

FIG. 10 depicts a flow chart of an example method 1000 that can desirably (e.g., automatically, dynamically, suitably, reliably, efficiently, enhancedly, and/or optimally) train a discriminator model to infer or predict tokens that were replaced by predicted tokens (e.g., by the generator model) in a modified sequence of tokens associated with a log message to facilitate learning to infer or detect dynamic tokens in a subsequent log message, in accordance with various aspects and embodiments of the disclosed subject matter. The method 1000 can be employed by, for example, a system comprising the template generation manager component, the processor component, the data store, and/or other components, wherein the template generation manager component can comprise various components, such as described herein. In some embodiments, the method 1000 can proceed from reference point A. In some embodiments, the training of the generator model and the discriminator model can be performed concurrently. In other embodiments, the training of the generator model and the discriminator model can be performed separately. In accordance with various embodiments, a model (e.g., a single model) can comprise the generator model and the discriminator model (e.g., generator model component and discriminator model component), or, alternatively, the generator model and the discriminator model can be separate models.

At 1002, with regard to each log message of the group of log messages, a modified sequence of tokens can be generated, wherein the modified sequence can comprise a portion of the respective encoded tokens and certain predicted tokens that can replace other respective encoded tokens. The token sequence processor component can modify the sequence of respective encoded tokens or the masked sequence, by randomly replacing some or all of the masked tokens and/or some of the respective encoded tokens with the respective predicted tokens, to generate the modified sequence of tokens, wherein the respective predicted tokens can be the tokens predicted by the generator model. For instance, the token sequence processor component can randomly select positions in the sequence or masked sequence, and, with regard to each of those positions, can replace the masked token or original encoded token with the predicted token that was predicted by the generator model.

At 1004, respective labels can be associated with respective tokens of the modified sequence of tokens, wherein each label can indicate whether the associated token is the original encoded token or a replaced token. In some embodiments, with regard to each token of the modified sequence, the token sequence processor component can associate (e.g., assign, map, or otherwise associate) a label that can indicate whether the associated token is an original encoded token or a replaced token (e.g., a predicted token that replaces the original encoded token). In some instances, a replacement predicted token can replace a masked token, which had replaced an original encoded token (e.g., at that position in the sequence). In certain instances, a replacement predicted token can replace an original encoded token. In some cases, the replacement predicted token can have a different token value than the corresponding (e.g., position-wise) original encoded token, and, in other cases, the replacement predicted token may have the same token value as the corresponding original encoded token.

At 1006, the modified sequence of tokens and the respective labels associated with the respective tokens of the modified sequence can be input into a discriminator model. The AI component, employing the trainer component, can input the modified sequence of tokens and the respective labels into the discriminator model. In some embodiments, the trainer component also can input the original sequence of respective encoded tokens into the discriminator model for analysis.

At 1008, with regard to each token in the modified sequence of tokens, the discriminator model can determine a probability, and facilitate predicting whether, the token is the original encoded token or the replaced token based at least in part on the results of performing an AI-based analysis on the modified sequence of tokens, the respective labels, and/or the original sequence of respective encoded tokens. For instance, with regard to each token in the modified sequence of tokens, the discriminator model can determine or predict the probability (e.g., a probability value) that the token is the original encoded token or the replaced token, to facilitate predicting or inferring whether the token is the original encoded token or the replaced token, based at least in part on the AI-based analysis results.

At 1010, with regard to the respective probabilities of whether respective tokens have been replaced or not, an amount of loss between the respective probabilities and the respective (e.g., corresponding) labels associated with the respective tokens can be determined based at least in part on a result of comparing the respective probabilities to the respective labels. The AI component, employing the loss determinator component, can determine (e.g., calculate) the amount of loss between the respective probabilities (e.g., respective probability values) and the respective labels (e.g., respective label values) based at least in part on the result of comparing the respective probabilities to the respective labels.

At 1012, an update to respective parameters associated with the discriminator model can be determined based at least in part on the amount of loss. For instance, with regard to the amount of loss associated with determining or predicting the respective probabilities that the respective tokens are the original encoded token or the replaced token, the AI component, employing the update component, can determine the update to the respective parameters (e.g., hyperparameters and/or other parameters) associated with the discriminator model to mitigate (e.g., reduce or minimize) the loss (e.g., mitigate the amount of loss associated with the token replacement predictions or inferences).

At 1014, the respective parameters associated with the discriminator model can be updated based at least in part on the update. The update component can update (e.g., adjust or modify) the respective parameters associated with the discriminator model to facilitate mitigating the loss associated with the token replacement predictions or inferences.

At 1016, for respective positions of the modified sequence, the discriminator model can generate, as an output, respective inferences, predictions, or probabilities of whether the respective tokens at the respective positions are an original encoded token or a replacement token. For instance, for each position t in the modified sequence, the discriminator model can determine and generate, as the output, the respective inferences, predictions, or probabilities of whether the respective tokens x, at the respective positions t are an original encoded token (e.g., for the respective position) or a replacement token.

In some embodiments, the method 1000 can return to reference numeral 1002 to perform one or more additional iterations of training of the discriminator model, for example, until the defined model management criteria is satisfied (e.g., until a defined accuracy criterion (of the defined model management criteria), which can indicate that the discriminator model is desirably accurate in predicting or inferring whether tokens in a sequence are original encoded tokens or replaced tokens, has been satisfied, or until the defined model training stopping criterion (of the defined model management criteria) is satisfied).

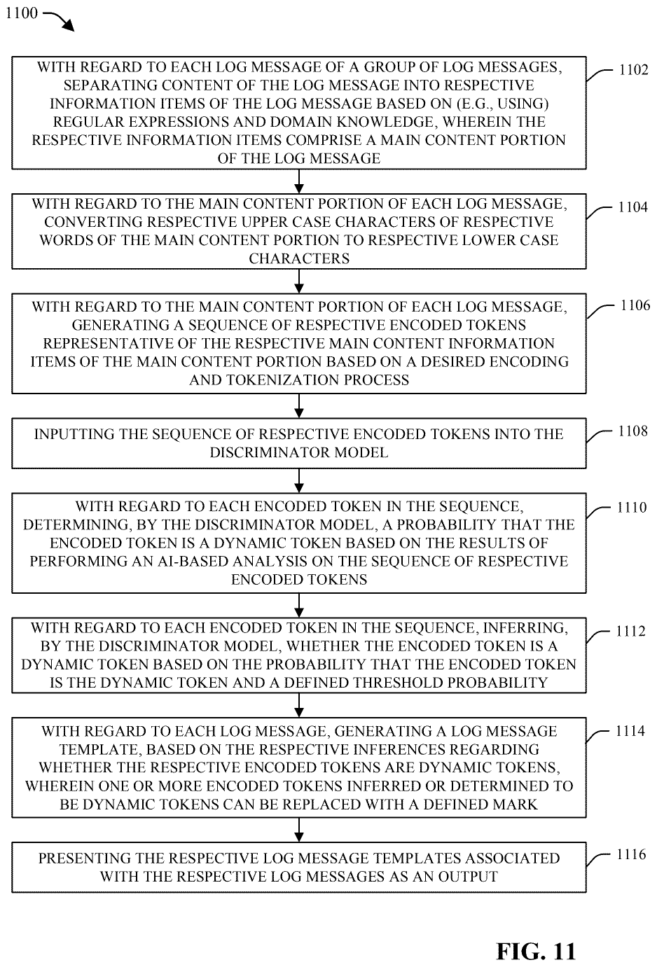

FIG. 11 depicts a flow chart of an example method 1100 that can desirably (e.g., automatically, dynamically, suitably, reliably, efficiently, enhancedly, and/or optimally) use a trained discriminator model to infer or detect dynamic tokens associated with a log message, and can desirably generate a log message template that can comprise defined marks that can replace the dynamic tokens associated with the log message, in accordance with various aspects and embodiments of the disclosed subject matter. The method 1100 can be employed by, for example, a system comprising the template generation manager component, the processor component, the data store, and/or other components, wherein the template generation manager component can comprise various components (including the trained discriminator model), such as described herein.

At 1102, with regard to each log message of a group of log messages, separating content of the log message into respective information items of the log message based at least in part on (e.g., using) regular expressions and domain knowledge, wherein the respective information items comprise a main content portion of the log message. The expression processor component can identify (e.g., determine) the respective information items in the content of the log message and can separate (e.g., divide or segment) the content into the respective information items and/or extract the respective information items from the log message based at least in part on the regular expressions and the domain knowledge, wherein the domain knowledge can relate to the group of log messages. In some embodiments, the expression processor component can separate the main content portion, including respective main content information items contained therein, from the other respective information items (e.g., timestamp, severity level, and/or other structured information items) of the log message. The main content portion can be or can comprise unstructured information (e.g., main content information items that may not be associated with regular expressions).

At 1104, with regard to the main content portion of each log message of the group of log messages, respective upper case characters of respective words of the main content portion can be converted to respective lower case characters. The expression processor component or another component of the template generation manager component can identify the respective upper case characters of the respective words of the main content portion and can convert the respective upper case characters to respective lower case characters.

At 1106, with regard to the main content portion of each log message of the group of log messages, a sequence of respective encoded tokens representative of the respective main content information items of the main content portion can be generated based at least in part on a desired encoding and tokenization process. In some embodiments, the tokenizer component can encode and tokenize the respective main content information items (e.g., with upper case characters converted to lower case characters) to generate the sequence of respective encoded tokens using the desired encoding and tokenization process (e.g., BPE or other desired encoding and tokenization process).

At 1108, the sequence of respective encoded tokens can be input into the discriminator model. The AI component, employing the trainer component, can input the sequence of respective encoded tokens into the discriminator model (e.g., the trained discriminator model).

At 1110, with regard to each encoded token in the sequence of respective encoded tokens, the discriminator model can determine a probability that the encoded token is a dynamic token based at least in part on the results of performing an AI-based analysis on the sequence of respective encoded tokens. For instance, with regard to each encoded token in the sequence of respective encoded tokens, the trained discriminator model can determine (e.g., calculate) or predict the probability (e.g., a probability value) that the encoded token is a dynamic token based at least in part on the analysis results, such as described herein.

At 1112, with regard to each encoded token in the sequence of respective encoded tokens, the discriminator model can infer whether the encoded token is a dynamic token based at least in part on the probability that the encoded token is the dynamic token and a defined threshold probability. For instance, with regard to each encoded token in the sequence of respective encoded tokens, the trained discriminator model can infer whether the encoded token is the dynamic token based at least in part on the probability (e.g., probability value) that the encoded token is the dynamic token and the defined threshold probability (e.g., defined threshold probability value). For example, the trained discriminator model can compare the probability associated with the encoded token to the defined threshold probability to determine whether the probability is at or greater than the defined threshold probability to facilitate inferring whether the encoded token is the dynamic token. If the probability is at or greater than the defined threshold probability, the trained discriminator model can infer that the encoded token is a dynamic token. If the probability is less than the defined threshold probability, the trained discriminator model can infer that the encoded token is not a dynamic token.

At 1114, with regard to each log message, a log message template can be generated, based at least in part on the respective inferences regarding whether the respective encoded tokens are dynamic tokens, wherein one or more encoded tokens inferred or determined to be dynamic tokens can be replaced with a defined mark. The template generator component or another component of the template generation manager component can determine one or more encoded tokens of the sequence that can be dynamic tokens based at least in part on the respective inferences regarding whether the respective encoded tokens are dynamic tokens (e.g., based at least in part on one or more inferences associated with the one or more encoded tokens indicating that the one or more encoded tokens can be dynamic tokens). With regard to each log message, the template generator component can generate and/or extract a log message template based at least in part on the respective inferences regarding whether the respective encoded tokens are dynamic tokens, wherein the one or more encoded tokens inferred or determined to be dynamic tokens can be replaced with the defined mark (e.g., defined textual string, symbol, or character). The template generator component can decode or otherwise process the non-dynamic encoded tokens representative of the main content portion (e.g., representative of at least a portion of the main content portion) of the log message to generate (e.g., recreate) the respective textual information of the respective non-dynamic encoded tokens that can be positioned in the log message template at the respective locations in the main content portion associated with the respective non-dynamic encoded tokens (and associated with the respective original textual information of the main content portion), and, with regard to the one or more dynamic tokens, the template generator component can replace the one or more dynamic tokens with the defined mark in the one or more respective positions (e.g., locations) in the main content portion of the log message template where those one or more dynamic tokens are located. The template generator component also can include the respective information items (e.g., structured information items) that were previously separated from the main content portion of the log message in their respective positions in the log message template.

At 1116, the respective log message templates associated with the respective log messages of the group of log messages can be presented as an output. The template generator component or another component of the template generation manager component can present (e.g., communicate, display, or otherwise present) the respective log message templates associated with the respective log messages as an output.

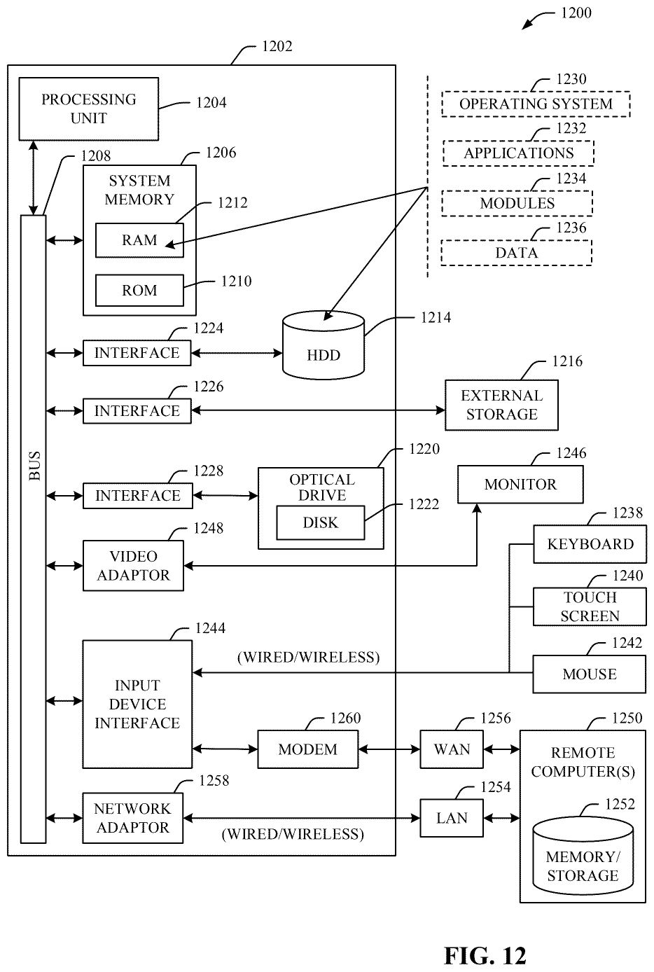

In order to provide additional context for various embodiments described herein, FIG. 12 and the following discussion are intended to provide a brief, general description of a suitable computing environment 1200 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 also can be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256, e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., template generation manager component, device, expression processor component, tokenizer component, token sequence processor component, AI component, generator model, discriminator model, detector component, template generator component, recovery component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
with regard to a first sequence comprising respective encoded tokens partially representative of a log message and a masked token that replaces an encoded token associated with the log message in the first sequence, training, by a system comprising at least one processor, a generator model to generate a predicted token that is a prediction of the encoded token that was replaced by the masked token in the first sequence, based on a first artificial intelligence-based analysis performed on the first sequence using the generator model;
generating, by the system, a second sequence comprising respective tokens that comprise the predicted token and at least some of the respective encoded tokens, wherein the predicted token is a replacement token that replaces the masked token of the first sequence to facilitate generating the second sequence; and
based on a second artificial intelligence-based analysis performed, using a discriminator model, on the second sequence and respective label values associated with the respective tokens, training, by the system, the discriminator model to predict whether the respective tokens of the second sequence are the respective encoded tokens or the replacement token, wherein the training of the discriminator model enables the discriminator model to perform inferential detection of a dynamic token associated with a subsequent log message and enables replacement of the dynamic token with a defined mark to facilitate generation of a log message template that is representative of the subsequent log message and comprises the defined mark in place of the dynamic token.

2. The method of claim 1, further comprising:
separating, by the system, respective log messages into respective structured information items and respective main content portions of the respective log messages, based on domain knowledge of a domain associated with the respective log messages and using defined regular expressions, wherein the respective log messages comprise the log message, and wherein the respective main content portions comprise respective unstructured information items;
generating, by the system, the respective encoded tokens representative of the respective unstructured information items of the respective main content portions based on applying an encoding and tokenization process to the respective unstructured information items;
generating, by the system, respective first sequences comprising the respective encoded tokens and respective masked tokens, wherein the respective first sequences comprise the first sequence, wherein the respective masked tokens comprise the masked token, and wherein, in each of the respective first sequences, one or more respective masked tokens replace one or more of the respective encoded tokens that are randomly selected for replacement, to facilitate the generating of the respective first sequences; and
inputting, by the system, the respective first sequences into the generator model to facilitate performance of the first artificial intelligence-based analysis on the respective first sequences using the generator model,
wherein the training of the generator model comprises: based on the first artificial intelligence-based analysis performed on the respective first sequences using the generator model, training the generator model to generate respective predicted tokens that are respective predictions of respective certain encoded tokens, associated with the respective main content portions, that were replaced by the respective masked tokens in the respective first sequences, and wherein the respective certain encoded tokens comprise the encoded token.

3. The method of claim 2, wherein the applying of the encoding and tokenization process comprises performing byte pair encoding on the respective information items to facilitate encoding and tokenizing the respective information items to generate the respective encoded tokens.

4. The method of claim 2, further comprising:
generating, by the system, respective second sequences comprising the respective tokens that comprise at least some of the respective encoded tokens and at least some of the respective predicted tokens, wherein the respective predicted tokens are respective replacement tokens that replace the respective masked tokens or certain other of the respective encoded tokens of the respective first sequences to facilitate the generating of the respective second sequences, wherein the respective second sequences comprise the second sequence, and wherein the respective replacement tokens comprise the replacement token;
associating, by the system, the respective labels with the respective tokens, wherein the respective labels indicate whether the respective tokens are the respective encoded tokens or the respective replacement tokens; and
inputting, by the system, the respective second sequences and the respective label values into the discriminator model to facilitate performance of the second artificial intelligence-based analysis on the respective second sequences using the discriminator model,
wherein the training of the discriminator model comprises: based on the second artificial intelligence-based analysis performed on the respective second sequences and the respective label values using the discriminator model, training the discriminator model to predict whether the respective tokens of the respective second sequences are the respective encoded tokens or the respective replacement tokens.

5. The method of claim 1, wherein the training of the generator model to generate the predicted token is a first iteration of the training of the generator model, and wherein the method further comprises:
determining, by the system, an amount of error between the predicted token and the encoded token based on a result of an analysis of the predicted token and the encoded token;
based on the amount of error, determining, by the system, update information relating to an update to a group of parameters associated with the generator model; and
based on the update information, performing, by the system, the update of the group of parameters associated with the generator model, to facilitate the training of the generator model and reducing a subsequent amount of error associated with a subsequent predicted token that is a prediction, using the generator model, of a subsequent encoded token that was replaced by a subsequent masked token to generate a subsequent first sequence, during a subsequent iteration of the training of the generator model.

6. The method of claim 1, wherein the first sequence comprises respective first tokens that are the respective encoded tokens and at least one masked token comprising the masked token, wherein the respective tokens of the second sequence are respective second tokens, and wherein the method further comprises:
outputting, using the generator model of the system, respective probability values that the respective tokens of the second sequence are the respective encoded tokens or respective replacement tokens at respective positions of the second sequence.

7. The method of claim 1, wherein the training of the discriminator model to predict whether the respective tokens of the second sequence are the respective encoded tokens or the replacement token is part of a first iteration of the training of the discriminator model, and wherein the method further comprises:
determining, by the system, an amount of error between the respective label values and respective probability values that the respective tokens are the respective encoded tokens or respective replacement tokens based on a result of an analysis of the respective label values and the respective probability values;
based on the amount of error, determining, by the system, update information relating to an update to a group of parameters associated with the discriminator model; and
based on the update information, performing, by the system, the update of the group of parameters associated with the discriminator model, to facilitate the training of the discriminator model and reducing a subsequent amount of error associated with subsequent predictions, using the discriminator model, of whether respective subsequent tokens of respective subsequent second sequences are respective subsequent encoded tokens or subsequent replacement tokens, during a subsequent iteration of the training of the discriminator model.

8. The method of claim 1, further comprising:
outputting, using the discriminator model of the system, respective probability values that the respective tokens of the second sequence are the respective encoded tokens or respective replacement tokens at respective positions of the second sequence.

9. The method of claim 1, further comprising:
in response to receiving the subsequent log message, generating, by the system, a subsequent sequence, comprising respective subsequent encoded tokens partially representative of the subsequent log message, wherein the subsequent log message further comprises respective structured information items;
performing, using the discriminator model of the system, a third artificial intelligence-based analysis on the respective subsequent encoded tokens of the subsequent sequence; and
based on the third artificial intelligence-based analysis, inferring, using the discriminator model of the system, whether the respective subsequent encoded tokens are respective dynamic tokens.

10. The method of claim 9, further comprising:
in response to determining, based on the inferring, that one or more of the respective subsequent encoded tokens are one or more respective dynamic tokens, replacing, by the system, the one or more respective dynamic tokens with one or more respective defined marks in one or more respective positions of the subsequent sequence where the one or more respective dynamic tokens are located, wherein other of the respective subsequent encoded tokens are determined to not be dynamic tokens based on the inferring, and wherein the other of the respective subsequent encoded tokens are representative of respective information items of the subsequent log message; and
generating, by the system, the log message template representative of the subsequent log message, wherein the log message template comprises the respective structured information items, the one or more respective defined marks, and the respective information items.

11. The method of claim 10, wherein the one or more dynamic tokens are representative of one or more respective dynamic information items of the subsequent log message, and wherein the method further comprises:
recovering, by the system, the one or more respective dynamic information items of the subsequent log message based on a result of comparing the log message template and the subsequent log message.

12. A system, comprising:
at least one memory that stores computer executable components; and
at least one processor that executes computer executable components stored in the at least one memory, wherein the computer executable components comprise:
a tokenizer that generates a first sequence comprising respective encoded tokens representative of part of a log message, wherein a masked token replaces an encoded token associated with the log message in the first sequence,
wherein the tokenizer further generates a second sequence comprising respective tokens that comprise a predicted token and at least some of the respective encoded tokens, wherein the predicted token is a replacement token that replaces the masked token of the first sequence to facilitate generation of the second sequence, wherein the predicted token is a prediction of the encoded token that was replaced by the masked token in the first sequence, wherein the predicted token was obtained as output from a generator model that was trained to generate the predicted token, wherein the predicted token was generated based on a first result of a first artificial intelligence-based analysis performed on the first sequence using the generator model, and
wherein a discriminator model is trained to predict whether the respective tokens of the second sequence are the respective encoded tokens or the replacement token, based on a second result of a second artificial intelligence-based analysis performed, using the discriminator model, on the second sequence and respective label information items associated with the respective tokens; and
a detector that performs, using the discriminator model, inferential detection of a dynamic token associated with a subsequent log message to facilitate replacement of the dynamic token with a defined symbol to facilitate generation of a log message template that is representative of the subsequent log message and comprises the defined symbol in place of the dynamic token.

13. The system of claim 12, wherein a model comprises the generator model and the discriminator model, and wherein the computer executable components further comprise:
an encoder of or associated with the tokenizer, wherein the encoder and the tokenizer are shared or utilized by the generator model and the discriminator model, and wherein the encoder encodes tokens for generator tasks performed by the generator model and discriminator tasks performed by the discriminator model.

14. The system of claim 13, wherein the computer executable components further comprise:
an expression processor that divides respective log messages into respective structured information items and respective main content portions of the respective log messages, based on domain knowledge of a domain associated with the respective log messages and using defined regular expressions, wherein the respective log messages comprise the log message, wherein the respective main content portions comprise respective unstructured information items,
wherein at least one of the tokenizer or the encoder generates the respective encoded tokens representative of the respective unstructured information items of the respective main content portions based on a specified encoding and tokenization process,
wherein the tokenizer generates respective first sequences comprising the respective encoded tokens and respective masked tokens, wherein the respective first sequences comprise the first sequence, wherein the respective masked tokens comprise the masked token, wherein, in each of the respective first sequences, one or more of the respective masked tokens replace one or more of the respective encoded tokens that are randomly selected for replacement, to facilitate the generation of the respective first sequences, and
wherein the respective first sequences are input into the generator model to facilitate performance of the first artificial intelligence-based analysis on the respective first sequences using the generator model.

15. The system of claim 14, wherein the tokenizer generates respective second sequences comprising the respective tokens that comprise at least some of the respective encoded tokens and at least some of the respective predicted tokens, wherein the respective predicted tokens are respective replacement tokens that replace the respective masked tokens or certain other of the respective encoded tokens of the respective first sequences to facilitate the generation of the respective second sequences, wherein the respective second sequences comprise the second sequence, wherein the respective replacement tokens comprise the replacement token,
wherein the respective second sequences and respective label values associated with the respective tokens are input into the discriminator model to facilitate performance of the second artificial intelligence-based analysis on the respective second sequences using the discriminator model, and wherein the respective labels indicate whether the respective tokens are the respective encoded tokens or the respective replacement tokens.

16. The system of claim 12, wherein the generator model being trained utilizing the first sequence occurs during a first iteration of training of the generator model, wherein the first sequence comprises respective first tokens that are the respective encoded tokens and at least one masked token comprising the masked token, wherein the respective tokens of the second sequence are respective second tokens, wherein the generator model generates, as an output, respective probability values that the respective tokens of the second sequence are the respective encoded tokens or respective replacement tokens at respective positions of the second sequence, and wherein the computer executable components further comprise:
a loss determinator that determines an amount of loss between the predicted token and the encoded token based on a third result of an analysis of the predicted token and the encoded token; and
an updater that determines an update to a group of parameters associated with the generator model based on the amount of loss, wherein, based on the update, the updater performs or facilitates performance of the update to modify the group of parameters associated with the generator model, to facilitate the generator model being trained and mitigation of a subsequent amount of loss associated with a subsequent predicted token that is a prediction, using the generator model, of a subsequent encoded token that was replaced by a subsequent masked token to generate a subsequent first sequence, during a subsequent iteration of the generator model being trained.

17. The system of claim 12, wherein the discriminator model being trained utilizing the second sequence occurs during a first iteration of the training of the discriminator model, wherein the discriminator model generates, as an output, respective probability values that the respective tokens of the second sequence are the respective encoded tokens or respective replacement tokens at respective positions of the second sequence, and wherein the computer executable components further comprise:
a loss determinator that determines an amount of loss between the respective label information items and the respective probability values that the respective tokens are the respective encoded tokens or the respective replacement tokens based on a third result of an analysis of the respective information items and the respective probability values; and
an updater that determine an update to a group of parameters associated with the discriminator model based on the amount of loss, wherein, based on the update, the updater performs or facilitates performance of the update to modify the group of parameters associated with the discriminator model, to facilitate the discriminator model being trained and mitigation of a subsequent amount of loss associated with subsequent predictions, using the discriminator model, of whether respective subsequent tokens of respective subsequent second sequences are respective subsequent encoded tokens or subsequent replacement tokens, during a subsequent iteration of the discriminator model being trained.

18. A non-transitory machine-readable medium, comprising executable instructions that, when executed by at least one processor, facilitate performance of operations, comprising:
in response to receiving a log message, generating, a sequence, comprising respective encoded tokens partially representative of the log message, wherein the log message further comprises respective structured information items;
performing, using a discriminator model, an artificial intelligence-based analysis on the respective encoded tokens of the sequence; and
based on a result of the artificial intelligence-based analysis, inferring, using the discriminator model, whether the respective encoded tokens are respective dynamic tokens to facilitate generating a log message template that is representative of the log message and comprises one or more defined symbols in place of one or more of the respective encoded tokens inferred to be one or more respective dynamic tokens.

19. The non-transitory machine-readable medium of claim 18, further comprising:
dividing the log message into the respective structured information items and a main content portion of the log message, based on domain knowledge of a domain associated with the log message and using defined regular expressions, wherein the main content portion comprises respective unstructured information items;
generating the respective encoded tokens representative of the respective unstructured information items of the main content portion based on applying an encoding and tokenization process to the respective unstructured information items, wherein the generating of the sequence comprises generating the sequence, comprising the respective encoded tokens, based on the generating of the respective encoded tokens; and
inputting the sequence, comprising the respective encoded tokens, into the discriminator model to facilitate performance of the artificial intelligence-based analysis on the sequence using the discriminator model.

20. The non-transitory machine-readable medium of claim 18, further comprising:
in response to determining, based on the inferring, that one or more of the respective encoded tokens are the one or more respective dynamic tokens, substituting one or more respective defined symbols for the one or more respective dynamic tokens in one or more respective positions of the sequence where the one or more respective dynamic tokens are located, wherein other of the respective encoded tokens are determined to not be dynamic tokens based on the inferring, wherein the other of the respective encoded tokens are representative of respective information items of the log message, and wherein the discriminator model and a generator model associated with the discriminator model are trained, in conjunction with each other, based on log messages, to enable the discriminator model to infer whether one or more of the respective encoded tokens of the sequence are the one or more respective dynamic tokens to facilitate the generating of the log message template; and
generating the log message template representative of the log message, wherein the log message template comprises the respective structured information items, the one or more respective defined symbols, and the respective information items.
